(19) United States
(12) Patent Application Publication
(10) Pub. No.: US 2021/0189922 A1
(43) Pub. Date: Jun. 24, 2021

(54) GEAR, BALANCER DEVICE, AND BALANCER DEVICE PROVIDED WITH OIL PUMP

(71) Applicant: HITACHI AUTOMOTIVE SYSTEMS, LTD., Hitachinaka-shi, Ibaraki (JP)

(72) Inventors: Masahumi KURITA, Yokohama-shi, Kanagawa (JP); Masaharu KITAMURA, Atsugi-shi, Kanagawa (JP)

(73) Assignee: HITACHI AUTOMOTIVE SYSTEMS, LTD., Hitachinaka-shi, Ibaraki (JP)

(21) Appl. No.: 17/050,537

(22) PCT Filed: Mar. 27, 2019
(86) PCT No.: PCT/JP2019/013056

§ 371 Date: Oct. 26, 2020

(30) Foreign Application Priority Data
Apr. 27, 2018 (JP) 2018-086309

(51) Int. Cl. F01M 1/02; F04C 29/00; F16H 55/14; F16F 15/26; F02B 67/06

(52) U.S. Cl. CPC F01M 1/02; F04C 29/0021; F04C 29/005; F16H 55/14; F01M 2001/0276; F02B 67/06; F04C 2270/135; F04C 2240/60; F16F 15/265

(57) ABSTRACT

A gear configured to rotate as a unit with a shaft, the gear includes: a plurality of annular grooves formed on both side surfaces of the gear in a direction of a rotation axis of the shaft, at least partially overlapped when viewed from the direction of the rotation axis, and at least partially overlapped in a radial direction with respect to the rotation axis.

### TECHNICAL FIELD

This invention relates to a gear, a balancer device, and a balancer device provided with an oil pump.

### BACKGROUND ART

For example, there has been known devices described in following patent documents 1 and 2, respectively, as a gear and a balancer device. The patent documents 1 and 2 disclose arts in which a plurality of groove portions are provided to the gear.

### PRIOR ART DOCUMENT

Patent Document
Patent Document 1: U.S. Pat. No. 2,207,290
Patent Document 2: Japanese Patent Application Publication No. 2014-134230

### SUMMARY OF THE INVENTION

### Problems which the Invention is Intended to Solve

However, in the conventional art, the groove portions are alternately provided on both side surfaces of the gear, so as to suppress the noise generated by the engagement of the gears. Accordingly, the size of the gear may be increased in a radial direction with respect to a rotation axis direction of the gear.

Moreover, in a case where the gear including the groove portions alternately provided on the both side surfaces of the gear are employed in the balancer device, the oil pump, and the balancer device provided with the oil pump, the sizes thereof may be increased.

It is, therefore, an object of the present invention to provide a gear, a balancer device, and a balancer device provided with an oil pump which are devised to solve the above-described problems, to suppress the noise generated by the engagement of the gears, and to suppress the size increase of the gear.

### Means for Solving the Problem

In one aspect according to the present invention, a gear configured to rotate as a unit with a shaft, the gear includes a plurality of annular grooves formed on both side surfaces of the gear, and partially overlapped when viewed in the direction of the rotation axis and the radial direction.

### Benefit of The Invention

By the present invention, it is possible to provide a gear, a balancer device, and a balancer device provided with an oil pump which are devised to suppress the noise generated by the engagement of the gears, and to suppress the size increase of the gear.

### BRIEF DESCRIPTION OF DRAWINGS

FIG. 1 is a front view showing a state in which a balancer device according to embodiments of the present invention is mounted on an engine.

FIG. 2 is a sectional view taken along a direction II-II of FIG. 1.

FIG. 3 is a perspective view showing a state where an oil pump according to the embodiments of the present invention is assembled to the balancer device.

FIG. 4 is a back view showing the oil pump and the balancer device according to the embodiments of the present invention.

FIG. 5 is a view of a housing device when viewed from a bottom portion in a case where a lower housing is detached in the embodiments of the present invention.

FIG. 6 is a plan view showing the balancer device according to the embodiments of the present invention.

FIG. 7 is a sectional view taken along a line VII-VII of FIG. 6.

FIG. 8 is a side view showing a plane bearing according to the embodiments of the present invention,

FIG. 9 is an exploded perspective view showing components of the oil pump according to the present invention.

FIG. 10 is a front view showing the oil pump in a state where a cover member is detached in the embodiments of the present invention.

FIG. 11A is a perspective view showing a main gear according to the embodiments of the present invention when viewed from a pump side.

FIG. 11B is a perspective view showing the main gear according to the embodiments of the present invention when viewed from an opposite pump side.

FIG. 11C is a plan view showing the main gear according to the embodiments of the present invention when viewed from the opposite pump side.

FIG. 11D is a sectional view taken along a direction XID-XID direction of FIG. 11C.

FIG. 12 is a partially enlarged view of a portion XII of FIG. 2.

FIG. 13A is a sectional view for explaining an actuation of the main gear and a balancer drive shaft according to a first embodiment of the present invention.

FIG. 13B is a view showing a relationship of a force acted to the main gear according to the first embodiment of the present invention.

FIG. 14A is a sectional view for explaining the actuation of the main gear and the balancer drive shaft according to the first embodiment of the present invention.

FIG. 14B is a view showing the relationship of the force acted to the main gear according to the first embodiment of the present invention.

FIG. 15A is a perspective view showing a crank gear according to the embodiments of the present invention, when viewed from the pump side.

FIG. 15B is a perspective view showing the crank gear according to the embodiments of the present invention, when viewed from the opposite pump side.

FIG. 15C is a plan view showing the crank gear according to the embodiments of the present invention, when viewed from the opposite pump side.

FIG. 15D is a sectional view taken along a direction XVD-XVD in FIG. 15C.

FIG. 16 is a sectional view showing a main gear according to a second embodiment of the present invention.

FIG. 17 is a sectional view showing a main gear according to a third embodiment of the present invention.

FIG. 18 is a sectional view showing a main gear according to a fourth embodiment of the present invention.

FIG. 19 is a sectional view showing a main gear according to a fifth embodiment of the present invention.

FIG. 20 is a sectional view showing a main gear according to a sixth embodiment of the present invention.

### DESCRIPTION OF EMBODIMENTS

Hereinafter, balancer devices according to embodiments of the present invention are explained. The present invention is not limited to the below-described embodiments. The present invention includes various variations and applications in a technical concept of the present invention.

### First Embodiment

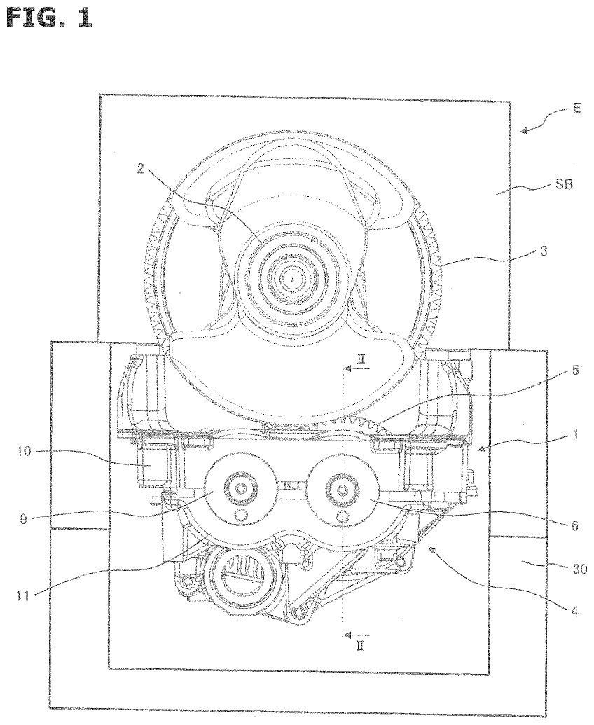

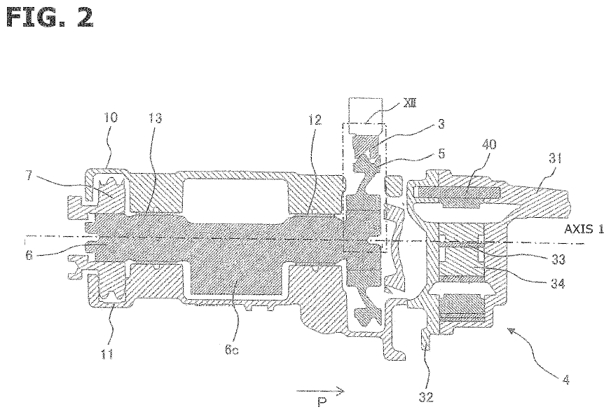

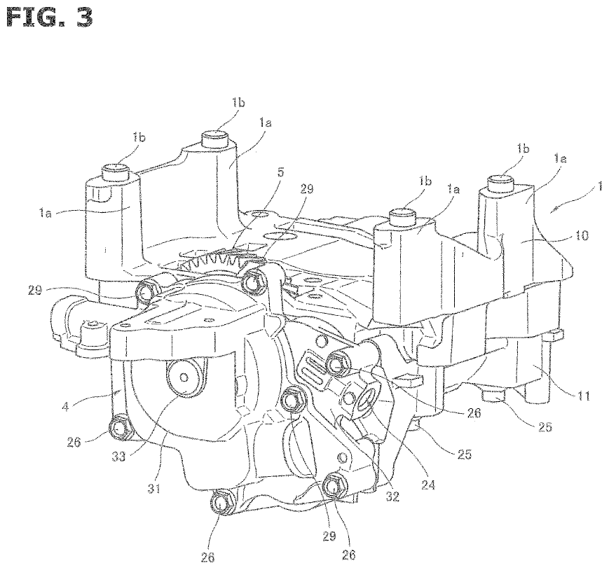

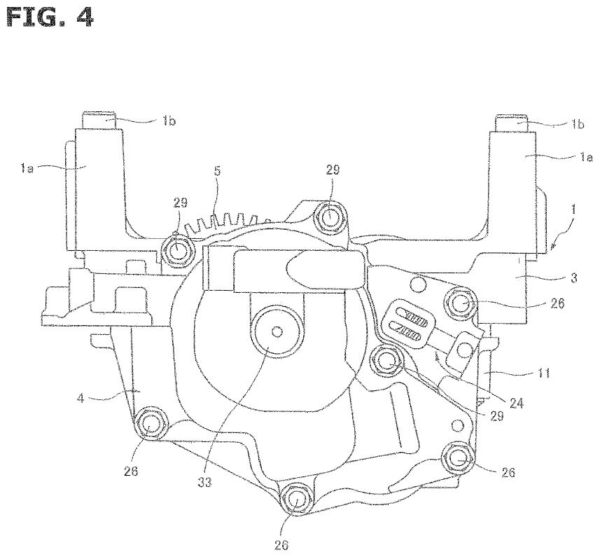

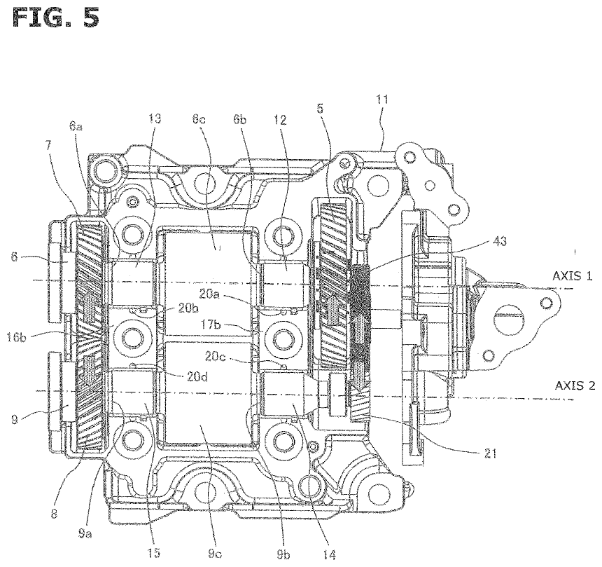

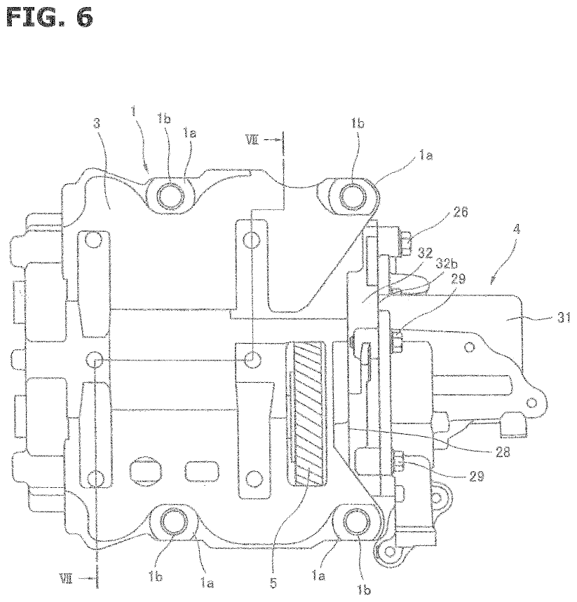

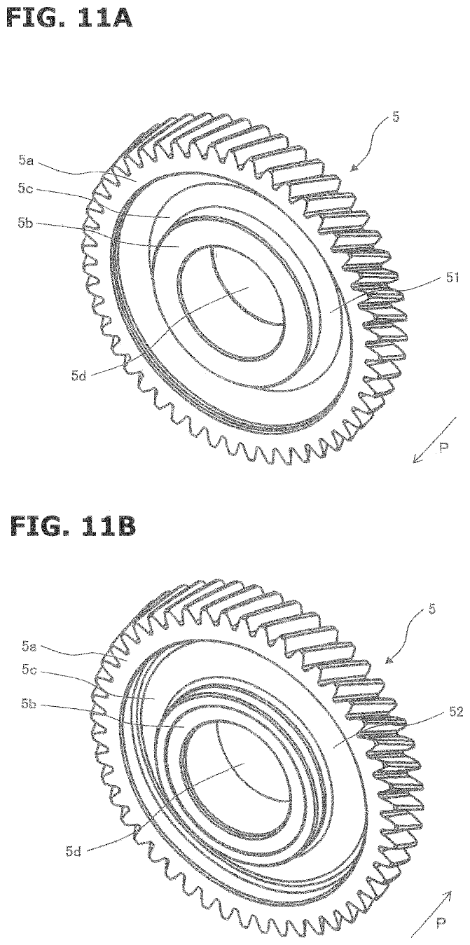

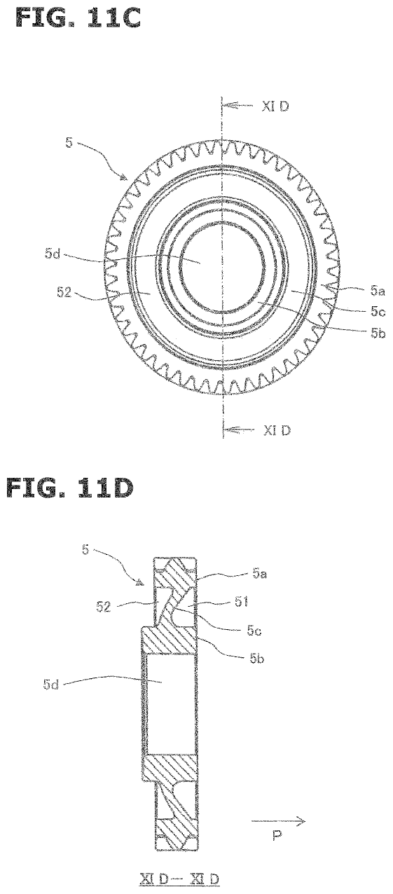

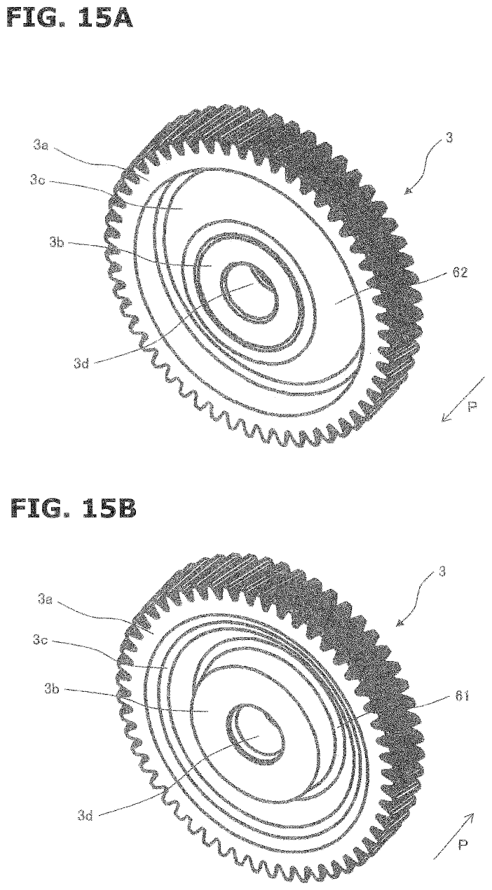

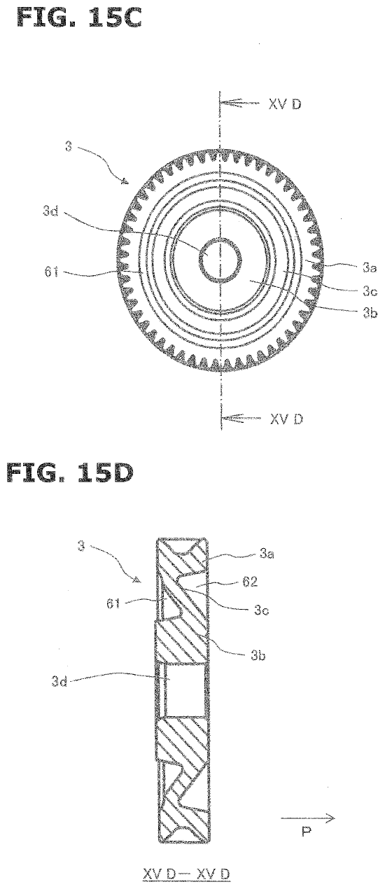

FIG. 1 is a front view showing a state in which a balancer device according to embodiments of the present invention is mounted on an engine. FIG. 2 is a sectional view taken along a direction II-II of FIG. 1. FIG. 3 is a perspective view showing a state where an oil pump according to the embodiments of the present invention is assembled to the balancer device. FIG. 4 is a back view showing the oil pump and the balancer device according to the embodiments of the present invention. FIG. 5 is a view of a housing device when viewed from a bottom portion in a case where a lower housing according to the embodiments of the present invention are detached. FIG. 6 is a plan view showing the balancer device according to the embodiments of the present invention. FIG. 7 is a sectional view taken along a line VII-VII of FIG. 6. An arrow P of FIG. 2 shows a direction of a pump side on which an oil pump 4 is disposed. The direction shown by the arrow P shows an identical direction in FIG. 11 and FIG. 15.

As shown in FIG. 1, the balancer device 1 is received within an oil pan 30 mounted to a lower portion of a cylinder block SB of an internal combustion engine E. The balancer device 1 is configured to be driven and rotated by a crank gear 3 fixed to a crank shaft 2.

An oil pump 4 is integrally provided to the balancer device 1. The oil pump 4 is configured to receive the rotation force from the balancer device 1, and to be driven. Details are described later.

As shown in FIG. 1 to FIG. 5, the balancer device 1 includes a main gear (drive gear) 5 which is engaged with a crank gear (input gear) 3, and to which a rotation force from the crank gear 3 is transmitted; a balancer drive shaft 6 to which the rotation force from the main gear 5 is transmitted; a balancer drive gear 7 fixed to the balancer drive shaft 6; a balancer driven gear 8 including teeth engaged with teeth of the balancer drive gear 7; a balancer driven shaft 9 to which the rotation force from the balancer driven gear 8 is transmitted.

The oil pump 4 is configured to suck the oil stored in the oil pan 30, and to discharge and supply the oil into the internal combustion engine E.

As shown in FIG. 3 and FIG. 4, in the balancer device 1, a plurality of foot portions 1a (four foot portions in this embodiment) are fixed on a lower surface of the cylinder block SB of the internal combustion engine E through four mounting bolts (not shown) which are mounting means. The four foot portions 1a are integrally provided on the upper surface of the upper housing 10. Positioning hollow pins 1b protrude, respectively, from upper ends of the four foot portions 1a in the upward direction.

The balancer device 1 includes the upper housing 10; and a lower housing 11 which is tightened to the upper housing 10 on a bottom portion side of the oil pan 30 by tightening bolts 25 which a plurality of fixing means. Each of the upper housing 10 and the lower housing 11 is made from aluminum alloy which is metal material. The balancer drive shaft 6 and the balancer driven shaft 9 are rotatably supported in a receiving portion formed between the upper housing 10 and the lower housing 11. The balancer drive shaft 6 and the balancer driven shaft 9 are a pair of balancer shafts disposed in parallel with each other. The helical type main gear 5 is provided to one end portion of the balancer drive shaft 6 in the rotation axis direction of the balancer drive shaft 6. The main gear 5 is engaged with the crank gear 3 configured to be driven and rotated by the crank shaft 2, so as to receive the rotation force. Besides, as shown in FIG. 7, the upper housing 10 and the lower housing 11 are mutually positioned by two pins 25a and 25b.

Moreover, as shown in FIG. 5, the helical type valance drive gear 7 is fixed on the other end side of the balancer drive shaft 6 in the rotation axis direction of the balancer drive shaft 6 so as to rotate as a unit with the balancer drive shaft 6. Furthermore, the helical type balancer driven shaft 9 is fixed to the balancer driven shaft 9. The balancer drive shaft 9 is engaged with the balancer drive gear 7 to receive the rotation force.

These upper housing 10 and lower housing 11 constitute a balancer housing which is a housing.

The lower housing 11 is formed into a rectangular box shape which is substantially identical to the shape of the upper housing 10. Moreover, one end surface of the lower housing 11 is a flat mounted surface 28 (FIG. 6) to which the oil pump 4 is mounted. This mounted surface 28 includes a plurality of internal screw holes (not shown) (four internal screw holes in this embodiment) which are formed in a side portion.

As shown in FIG. 5, the balancer drive shaft 6 includes a pair of journal portions 6a and 6b which are located on both end sides in the rotation axis direction, and which are rotatably supported by a pair of plane bearings 12 and 13 which are bearing portions (bearing metals) provided between the upper housing 10 and the lower housing 11.

In the balancer drive shaft 6, the main gear 5 at the one end portion is engaged with the crank gear 3, so as to receive the rotation force of the crank shaft 2. Arrows in the drawing represent the rotation directions. In this way, when the balancer drive shaft 6 is rotated, the balancer drive gear 7 fixed at the other end of the balancer drive shaft 6 and the balancer driven gear 8 fixed at the balancer driven shaft 9 are rotated at double the speed of the crank shaft 2 in the opposite directions. That is, the balancer drive shaft 6 and the balancer driven shaft 9 perform two rotations per one rotation of the crank shaft 2.

Moreover, the balancer drive shaft 6 includes a semicircle balancer weight 6c integrally provided between the pair of journal portions 6a and 6b in the axial direction.

The balancer driven weight shaft 9 includes a pair of journal portions 9a and 9b which are formed on the both end sides of the rotation axis direction similarly to the balancer drive shaft 6, and which are rotatably supported by a pair of plane bearings 14 and 15 which are bearing portions (bearing metals) provided between the upper housing 10 and the lower housing 11. Moreover, a semi-circular balancer weight 9c (second balancer weight) is integrally provided between the pair of journal portions 9a and 9b.

As shown in FIG. 5 and FIG. 7, each of the plane bearings 12 to 15 has half circular shapes on the upper housing 10 side and the lower housing 11 side. Each of the plane bearings 12 to 15 has a cylindrical entire shape by contacting confronting end portions. The half portion of each of the plane bearings 12 to 15 is disposed within a semi-circular bearing groove formed between confronting surfaces of a pair of upper and lower partition walls 16a, 16b, 17a, and 17b provided between the upper housing 10 and the lower housing 11.

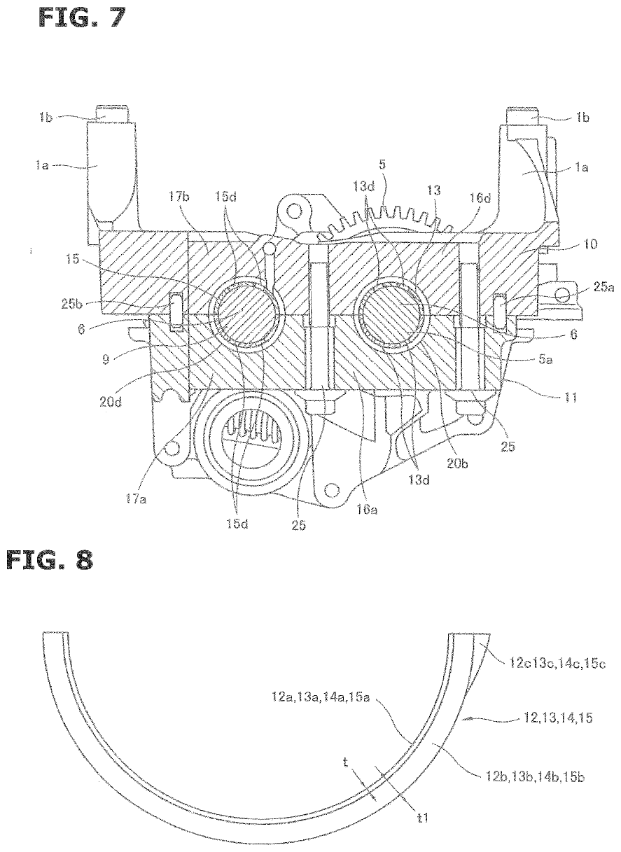

FIG. 8 is a side surface view of the lower half portion of the plane bearings 12 to 15 according to the embodiment of the present invention.

As shown in FIG. 8, each of the plane bearings 12 to 15 has a two layer configuration of the inner circumference portions 12a to 15a and the outer circumference portions 12b to 15b. The inner circumference portions 12a to 15a are mainly made from aluminum alloy which is soft metal. On the other hand, the outer circumference portions 12b to 15b are made from iron series metal.

In this way, the inner circumference portions 12a to 15a are mainly made from the soft aluminum alloy. With this, it is possible to embed the contamination such as the metallic wear debris entering between the inner circumference surfaces of the inner circumference portions 12a to 15a and the outer circumferences of the journal portions 6a, 6b, 9a, and 9b.

Moreover, each of the inner circumference portions 12a to 15a has a thickness t of substantially 0.2 mm. On the other hand, the outer circumference portions 12b to 15b has a thickness ti of substantially 1.3 mm. Furthermore, rotation stop protrusions 12c to 15c are provided on the outer circumference surfaces of the outer circumference portions 12b to 15b. Each of the rotation stop protrusions 12c to 15c is configured to restrict co-rotation during the rotations of the balancer drive shaft 6 and the balancer driven shaft 9.

Moreover, a passage groove (not shown) is formed in a confronting surface of each of the partition walls 16a, 16b, 17a, and 17b which confronts the lower housing 11. Each of the passage grooves is configured to supply the lubricant oil of the plane bearings 12 to 15. The passage grooves are connected to annular grooves 20a, 20b, 20c, and 20d shown in FIG. 5 and FIG. 7. Each of the annular grooves 20a to 20d is formed at a substantially central portion of the inner circumference surface of each of the bearing grooves in the widthwise direction.

As shown in FIG. 7, the plane bearings 13 and 15 includes connection holes 13d and 15d which are oil holes formed in the circumferential wall at predetermined positions to penetrate through the circumferential wall, and connected to the annular grooves 20b and 20d. The four connection holes 13d are formed on the same circumference at substantially central position of the widthwise direction of the circumferential wall of the plane bearing 13 (two in each bearing). The four connection holes 15d are formed on the same circumference at substantially central position of the widthwise direction of the circumferential wall of the plane bearing 15 (two in each bearing). These connection holes 13d and 15d are configured to introduce the oil into the clearances between the inner circumference surfaces of the inner circumference portions 13a and 15a and the outer circumference surfaces of the journal portions 6a and 9a. Besides, the oil is introduced into the plane bearings 12 and 14 by the similar configurations, although these are not shown.

The balancer driven shaft 9 includes one end portion in the rotation axis direction (the opposite side of the balancer driven gear 8). The oil pump drive gear 21 is fixed at the one end portion of the balancer driven shaft 9. The oil pump drive gear 21 is an outer gear having a diameter smaller than that of the main gear 5. This oil pump drive gear 21 is configured to drive the oil pump 4.

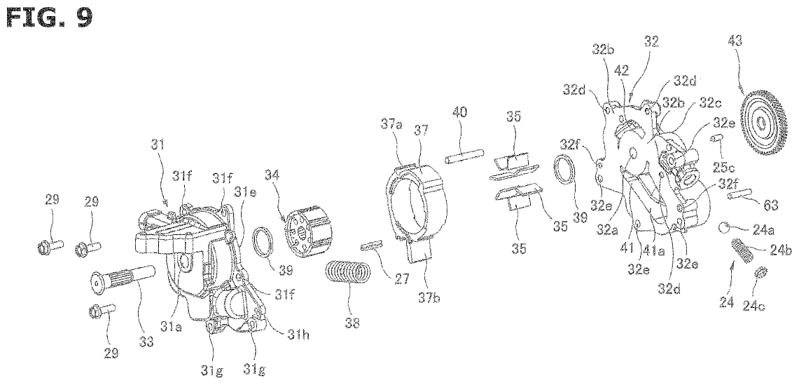

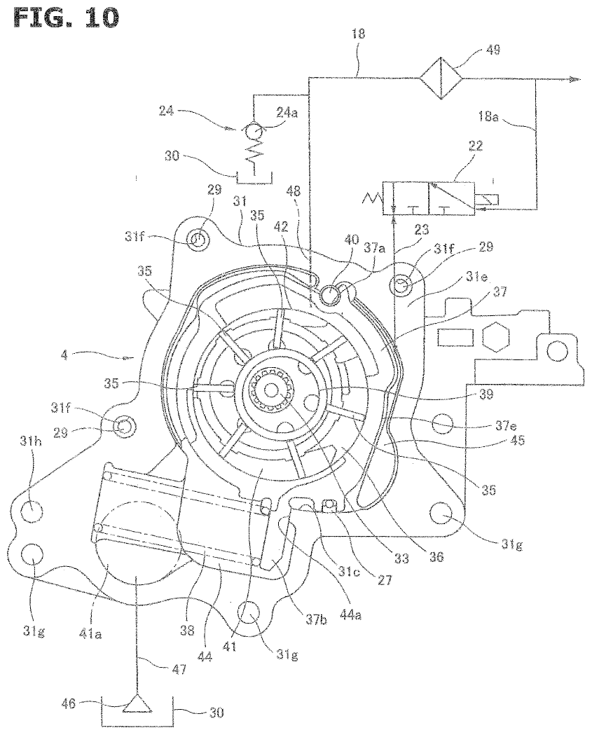

FIG. 9 is an exploded perspective view of the oil pump according to the embodiment of the present invention. FIG. 10 is a front view of the oil pump in a state where the cover member is detached.

The oil pump 4 is a normal variable displacement vane pump. Accordingly, the oil pump 4 is briefly explained. The pump housing 1 is mounted to the mounted surface 28 sides of the both housing 10 and 11 of the balancer device 1 by a plurality of bolts 26 (four bolts in this embodiment) which are fixing means.

This pump housing includes a housing main body 31 made from the resin and the metal such as the aluminum alloy; and the cover member 32 made from the aluminum alloy.

The housing main body 31 includes an opened one end side; and a pump receiving chamber. With this, the housing main body 31 has a U-shaped section. Moreover, the cover member 32 is mounted to close the opening of the housing main body 31. The cover member 32 has a thickness smaller than that of the housing main body 31.

Moreover, the oil pump 4 includes a pump shaft 33: a rotor 34; and vanes 35. The pump shaft 33 is disposed at a substantially central portion of the pump receiving chamber. The pump shaft 33 includes both end portions in the rotation axis directions. The both end portions of the pump shaft 33 penetrate through the housing main body 31 and the cover member 32. The both end portions of the pump shaft 33 are rotatably supported. The rotor 34 are rotatably received within the pump receiving chamber. A central portion of the rotor 34 is spline-connected to the pump shaft 33. The vanes 35 are received within a plurality of slots (seven slots in this embodiment) cut and formed in the outer circumference portion of the rotor 34 in the radial directions to be projectable and retractable from and into the slots.

Moreover, the oil pump 4 includes a cam ring 37; a coil spring 38 which is an urging member; and a pair of vane rings 39 and 39. The cam ring 37 has a ring shape having a circular hole formed in the inner circumference. Furthermore, the hole of the cam ring 37 is contacted on the outer circumference sides of the vanes 35.

Moreover, the cam ring 37 is configured to be swung. The cam ring 37 is configured to be swung to vary an eccentric amount of the hole of the cam ring 37 with respect to the center of the rotation of the rotor 34. A plurality of pump chambers 36 are formed by the inner circumference of the cam ring 37, the outer circumference surface of the rotor 34, and the adjacent vanes 35 and 35.

The coil spring 38 is received within the housing main body 31. The coil spring 38 is configured to constantly urge the cam ring 37 in a direction in which the eccentric amount of the center of the hole of the cam ring 37 with respect to the center of the rotation of the rotor 34 is increased.

The vane rings 39 and 39 are abutted on the inner circumference sides of the vanes 35 disposed within the slots of the rotor 34.

The cam ring 37, the pump shaft 33, the rotor 34, and the vanes 35 constitute a pump element.

The pump main body 31 includes a bearing hole 31a which is formed at a substantially central position of a bottom surface of the pump receiving chamber of the pump main body 31 to penetrate through the pump main body 31, and which rotatably supports the one end portion of the pump shaft 33. Furthermore, the pump main body 31 includes a pivot pin hole (not shown) which is formed in the bottom surface of the pump receiving chamber of the housing main body 31, and into which a pivot pin 40 is inserted. Moreover, a pin groove is formed in the inner circumference wall of the pump receiving chamber. The pin groove extends in the axial direction of the pivot pin 40.

Furthermore, a seal sliding surface 31c is formed on the inner circumference wall of the pump receiving chamber. A seal member 27 (described later) of the cam ring 37 is slidably abutted on the seal sliding surface 31c.

The housing main body 31 includes a plurality of bolt insertion holes 31F (three bolt insertion holes in this embodiment) formed in boss portions formed on the outer circumference side. A plurality of second bolts 29 (three second bolts in this embodiment) which are mounting means are inserted into these bolt insertion holes 31F, so as to connect the housing main body 31 and the cover member 32.

The housing main body 31 includes three bolt insertion holes 31g which penetrate through the housing main body 31, and into which three bolts 26 of four bolts 26 are inserted. Moreover, the housing main body 31 includes a positioning hole 31h which is similarly formed on a lower portion side to penetrate through the housing main body 31, and into which a positioning pin 63 to position the cover member 32 to the balancer device 1 is inserted.

As shown in FIG. 9, the cover member 32 includes a bearing hole 32a which is formed at a position confronting the bearing hole 31a so as to penetrate through the cover member 32, and which rotatably supports the other end side of the pump shaft 33 in the axial direction of the pump shaft 33. This cover member 32 includes a housing mounting surface 32b which is on the inner end side, and to which the housing main body 31 is mounted; and a balancer mounting surface 32c which is on the outer end side, and which is abutted and mounted on the mounted surface 28 of the balancer device 1.

The cover member 32 includes three internal screw holes 32d which are formed on the outer circumference portion side, and in which three second bolts 29 are fixed. Moreover, the cover member 32 includes four bolt insertion holes 32e which penetrate through the cover member 32, and into which the four bolts 26 are inserted.

The cover member 32 includes two positioning holes 32F which penetrate through the cover member 32, and into which the positioning pins 25c and 63 are inserted.

Each of the housing main body 31 and the cover member 32 include a suction port 41 and a discharge port 42 which are formed on the outer circumference sides of the mounting surfaces 31e and 32e confronting each other. The suction port 41 is a suction portion. The discharge port 42 is a discharge port. The suction port 41 is formed and opened in a region (suction region) in which the internal volumes of the pump chambers 36 are increased in accordance with the pump operation of the pump element. The suction port 41 has an arc recessed shape. On the other hand, the discharge port 42 is formed and opened in a region (discharge region) in which the internal volumes of the pump chambers 36 are decreased in accordance with the pump operation of the pump element. The suction port 41 has an arc recessed shape. The suction port 41 and the discharge port 42 substantially confront each other to sandwich the bearing holes 31a and 32a.

As shown in FIG. 10, the suction port 41 includes a suction hole 41a which is disposed on a spring receiving chamber 44 (described later) side, and which is formed and opened to the outside to penetrate through the bottom wall of the cover member 32. With this, the lubricant oil within the oil pan 30 is sucked through a strainer 46, a suction passage 47, the suction hole 41a, and the suction port 41 to the pump chambers 36 in the suction region.

The discharge port 42 is connected to a discharge passage 48 formed in the bottom wall of the housing main body 31 to penetrate through the housing main body 31. This discharge passage 48 is connected through a discharge hole (not shown) on the downstream side of the discharge port 42 to the main oil gallery 18. Besides, the discharge passage 48 includes a part of the lower side of the discharge port 42, that is, a part between the discharge port 42 and the discharge hole.

The main oil gallery 18 is configured to supply the oil to an oil jet configured to inject the cooling oil to the piston, a valve timing control device, and bearings of the crank shaft 2.

An oil filter 49 is provided in the main oil gallery 18. The oil filter 49 is configured to catch the foreign object within the pressurized oil supplied from the discharge passage 48.

Moreover, a relief valve 24 is provided in the discharge passage 48. The relief valve 24 is configured to suppress the damage of the oil filter 49 when the discharge pressure is excessive. As shown in FIG. 8, the relief valve 24 includes a ball valve element 24a configured to open and close an opening end of a bifurcated passage bifurcated from the discharge passage 48; and a coil spring 24b configured to urge the ball valve element 24a in the closing direction; and an annular spring retainer 24c.

The main oil gallery 18 includes a supply passage 18a formed and bifurcated to supply the oil through the electromagnetic switching valve 22 to a control hydraulic chamber 45 described later.

The electromagnetic switching valve 22 is connected to a supply and discharge passage 23. The supply and discharge passage 23 is configured to introduce the hydraulic pressure of the main oil gallery 18 through the supply passage 18a to the control hydraulic chamber 45, and to discharge the oil within the control hydraulic chamber 45 to the oil pan 30. Moreover, the electromagnetic switching valve 22 includes a pilot port connected to a pilot passage (not shown) bifurcated from the supply passage 18a; a supply and discharge port connected to the supply and discharge port 23; a drain port connecting the supply and discharge passage 23 and the discharge passage; and a supply port connected to the supply passage 18a. The discharge passage is connected to the oil pan 30.

An oil pump driven gear 43 (driven side helical gear) is fixed by the press fit to the one end portion of the pump shaft 43 in the rotation axis direction, which protrudes from the bearing hole 32a. The oil pump driven gear 43 is engaged with the oil pump drive gear 21 (drive side helical gear). With this, the rotation force of the balancer driven shaft 9 is transmitted through the oil pump drive gear 21 and the oil pump driven gear 43 to the pump shaft 33.

Moreover, the pump shaft 33 is set to have the substantially identical rotation speed of the crank shaft by the speed reduction ratio between the oil pump drive gear 21 and the oil pump driven gear 43.

The rotor 34 includes an insertion hole which is formed at a center to penetrate through the rotor 34, and into which the pump shaft 33 is inserted. This insertion hole includes an inner circumference surface having a spline groove formed in the axial direction.

The movements of the vanes 35 to the inner circumference side of the rotor 34 are restricted by the vane rings 39 and 39. Accordingly, the rotor 34 can be moved relative to the cam ring 37 and the vane rings 39 and 39 in a state where the vanes 35 are abutted on the inner circumference surface of the cam ring 37 and the outer circumference surfaces of the vane rings 39 and 39.

The cam ring 37 is integrally formed into the cylindrical shape by molding the iron series metal by the sintering method. This cam ring 37 is configured to be swung about the pivot groove 37a formed in the outer circumference portion, and the pivot pin 40 which is a swinging fulcrum, and which is supported by the pin groove. Moreover, the cam ring 37 includes an arm portion 37b which is formed at a position substantially opposite side of the pivot groove 37a with respect to the center of the cam ring 37, which protrudes in the radial direction, and which is linked with the coil spring 38.

In this case, the coil spring 38 which is the urging member is received within the spring receiving chamber 44 of the housing main body 31 which is connected through the suction hole 41a to the pump receiving chamber.

This coil spring 38 is configured to constantly urge the cam ring 37 through the arm portion 37b in a direction in which the eccentric amount of the cam ring 37 with respect to the center of the rotation of the rotor 34 is increased (in the counter-clockwise direction in FIG. 10), by the elastic force based on a set load W. With this, an outer surface of the arm portion 37b of the cam ring 37 is pressed on a stopper surface 44a formed on the wall surface of the spring receiving chamber 44. In this state, the cam ring 37 is held at a position at which the eccentric amount of the cam ring 37 with respect to the center of the rotation of the rotor 34 is maximum.

Moreover, as shown in FIG. 10, a seal member 27 is received and held in a seal holding groove provided in the outer circumference portion of the cam ring 37 to confront the seal sliding surface 31c.

The control hydraulic chamber 45 is provided in the outer circumference region between the pivot groove 37a of the cam ring 37, and the seal member 27. This control hydraulic chamber 45 is separated by the pivot pin 40 and the seal member 27 between the inner circumference surface of the housing main body 31 and the outer circumference surface of the cam ring 37.

The control hydraulic chamber 45 is connected through the supply and discharge passage 23 and the electromagnetic switching valve 22 to the supply passage 18a. Accordingly, the hydraulic presser from the main oil gallery 18 is supplied through the supply passage 18a, the electromagnetic switching valve 22, and the supply and discharge passage 23 to the control hydraulic chamber 45. Moreover, the internal hydraulic pressure of the control hydraulic chamber 45 is discharged through the supply and discharge passage 23 and the electromagnetic switching valve 22.

The cam ring 37 includes a pressure receiving surface 37e which is an outer circumference surface confronting the control hydraulic chamber 45. The cam ring 37 is configured to provide the swing force (the movement force) in a direction in which the eccentric amount with respect to the center of the rotation of the rotor 34 is decreased (in the clockwise direction in FIG. 10) against the urging force of the coil spring 38, by the hydraulic pressure received by the pressure receiving surface 37e from the supply passage 18a.

That is, the internal hydraulic pressure of the control hydraulic pressure 45 is acted to the cam ring 37 in the direction in which the eccentric amount with respect to the center of the rotation of the rotor 34 is decreased, so as to control the movement amount of the cam ring 37 in the concentric direction.

In this case, the swing position of the cam ring 37 is balanced by a predetermined force relationship between the urging force in the eccentric direction of the cam ring 37 by the urging force of the coil spring 38, and the urging force based on the internal pressure of the control hydraulic chamber 45.

The electromagnetic switching valve 22 is configured to produce the solenoid thrust to be proportional to the duty ratio by the pulse current from the control unit, and to act the thrust to a three-way valve in a direction identical to the pilot pressure.

That is, when the pulse current from the control unit to the electromagnetic switching valve 22 is stopped, and the electromagnetic switching valve 22 is in the deenergized state (the duty ratio=0), there is no solenoid thrust. The electromagnetic switching valve 22 has a set pressure determined by the spring force.

With this, by the three-way valve, the supply and discharge passage 23 is disconnected to the supply and discharge port, and the supply and discharge passage 23 is connected to the drain port. With these, the internal hydraulic pressure of the control hydraulic chamber 45 is discharged to be the low pressure state.

When the control unit outputs a signal to energize the coil of the electromagnetic switching valve 22, and the energization amount (the duty ratio) is increased, the solenoid thrust is increased to assist the pilot pressure. Accordingly, in the electromagnetic switching valve 22, the three way valve is acted against the spring force so that the supply and discharge port is connected to the supply port, and so that the supply and discharge port is disconnected to the drain port. With this, the electromagnetic switching valve 22 can be actuated by the hydraulic pressure equal to or smaller than the set pressure of the spring force, and controlled to the constant low pressure.

Accordingly, the internal pressure of the control hydraulic chamber 45 is increased. The cam ring 37 is continuously swung in the concentric direction against the spring force of the coil spring 38 to decrease the pump discharge pressure.

The control unit is configured to control the actuation of the electromagnetic switching valve 22 based on the oil temperature and the water temperature of the engine, the driving state of the internal combustion engine such as the engine speed and the load, the hydraulic pressure information signal from the hydraulic pressure sensor (not shown) provided on the downstream side of the oil filter 49 of the main oil gallery 18, and so on. That is, the electromagnetic switching valve 22 is configured to continuously control the hydraulic pressure within the control hydraulic chamber 45 based on the hydraulic pressure information signal from the hydraulic pressure sensor. With this, the fuel economy is improved.

In the engagement portion of the gears, the teeth hitting noise is generated by the engagement of the gears. In particular, the semi-circular balancer weight 6c is attached to the balancer drive shaft 6. Accordingly, the balancer drive shaft 6 is rotated while being deformed in the arcuate shape. Consequently, the main gear 5 mounted to the balancer drive shaft 6 is rotated in a state where the main gear 5 is inclined. The teeth hitting noise is generated between the main gear 5 and the crank gear 3 engaged with the main gear 5 in accordance with the inclination of the main gear 5. Hereinafter, means to decrease the noise generated by the engagement of the gears is explained with reference to the drawings.

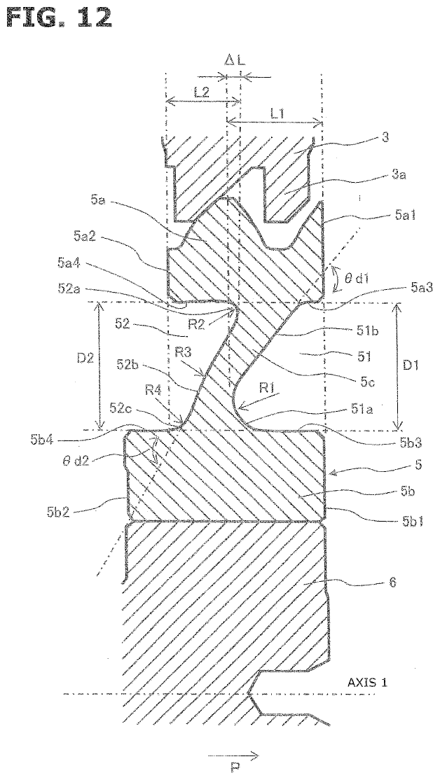

FIG. 11A is a perspective view showing a main gear according to the embodiments of the present invention when viewed from a pump side. FIG. 11B is a perspective view showing the main gear according to the embodiments of the present invention when viewed from an opposite pump side. FIG. 11C is a plan view showing the main gear according to the embodiments of the present invention when viewed from an opposite pump side. FIG. 11D is a sectional view taken along a direction XID-XID direction of FIG. 11C. FIG. 12 is a partially enlarged view of a portion XII of FIG. 2.

The main gear 5 includes an opening portion 5d which is formed at a central portion of the main gear 5, and through which the balancer drive shaft 6 passes. The teeth portion 5a of the main gear 5 has a predetermined torsion angle with respect to the rotation axis.

The teeth portion 5a of the main gear 5 is engaged with the teeth portion 3a of the crank gear 3. The teeth portion 3a of the crank gear 3 has a predetermined torsion angle with respect to the rotation axis. The balancer drive shaft 6 is inserted into the opening portion 5d of the main gear 5. The base portion 5b of the main gear 5 is fixed to the balancer drive shaft 6.

The main gear 5 includes a first annular groove 51 and a second annular groove 52 which are formed on both side surfaces of the main gear 5 in the rotation axis direction of the balancer drive shaft 6, and which are a plurality of annular grooves. The first annular groove 51 is formed on a first side surface which is in a direction of the thrust received by the teeth portion 5a. The second annular groove 52 is formed on a second side surface opposite to the first side surface on which the first annular groove 51 is formed. Moreover, the second annular groove 52 is overlapped with the first annular groove 51 when viewed from the direction of the rotation axis. In addition, the second annular groove 52 is partially overlapped with the first annular groove 51 in the radial direction with respect to the rotation axis. The overlapping portion in which the first annular groove 51 and the second annular groove 52 are overlapped is positioned on a side opposite to the side receiving the thrust.

A small thickness portion 5c is formed between the first annular groove 51 and the second annular groove 52. The small thickness portion Sc is disposed and inclined from the base portion 5b to the teeth portion 5a of the main gear 5 in the extension direction (the outside) of the rotation axis of the balancer drive shaft 6. That is, the small thickness portion 5c is inclined so that the side opposite to the balancer weight 6c side in the rotation axis direction directs to the outside in the radial direction.

The first annular groove 51 is recessed in the axially inward direction from the end surface portion 5b1 of the base portion 5b in the axial direction. The first annular groove 51 includes a curved surface portion 51a which is formed on the recessed bottom portion, and which has a predetermined radius of curvature R1. The end surface portion 5b1 and the curved surface portion 51a are connected by a first inner circumference surface 5b3 of the base portion 5b. The first inner circumference surface 5b3 is provided on the rotation axis side in the radial direction with respect to the rotation axis. A linear line portion 51b is formed on the surface of the small thickness portion 5c linearly extending from the curved surface portion 51a in the radially outward direction. The linear line portion 51b is connected to the first outer circumference surface 5a3 of the teeth portion 5a of the main gear 5. The first outer circumference surface 5a3 is connected to the end surface portion 5a1. The first inner circumference surface 5b3 confronts the first outer circumference surface 5a3. A depth of the first outer circumference surface 5a3 in the rotation axis direction is smaller than that of the first inner circumference surface 5b3.

On the other hand, the second annular groove 52 is recessed in the axially outward direction from the end surface portion 5a2 of the teeth portion 5a in the axial direction. The second annular groove 52 includes a curved surface portion 52a which is formed on the recessed bottom portion, and which has a predetermined radius of curvature R2. The end surface portion 5a2 and the curved surface portion 52a are connected by a second outer circumference surface 5a4 formed on the radially outer side (the teeth portion 5a side) with respect to the rotation axis. A curved surface portion 52b is formed on the surface of the small thickness portion 5c extending from the curved surface portion 52a in the radially inward direction. The curved surface portion 52b is bulged (raised) toward the opposite extension direction (the inner side) of the rotation axis to have a predetermined radius of curvature R3. The curved surface portion 52b is connected to the base portion 5b of the main gear 5 through a curved surface portion 52c having a predetermined radius of curvature R4. The curved surface portion 52c and the end surface portion 5b2 of the base portion 5b are connected by the second inner circumference surface 5b4 formed on the radially inner side (the rotation axis side) with respect to the rotation axis. The second inner circumference surface 5b4 confronts the second outer circumference surface 5a4. A depth of the second outer circumference surface 5a4 in the rotation axis direction is greater than that of the second inner circumference surface 5b4. Moreover, the first annular groove 51 is deviated from the second annular groove 52 in the radial direction with respect to the rotation axis.

The axial end surface portion 5b2 of the base portion 5b is positioned inside the axial end surface portion 5a2 of the teeth portion 5a in the rotation axis direction.

The first annular groove 51 is largely recessed in the axially inward direction at a position near the base portion 5b located radially inside the main gear 5. The first annular groove 51 has a recessed amount (a depth of the groove) which is smaller toward the radially outward side on which the teeth portion 5a is located. Conversely, the second annular groove 52 has a recessed amount (a depth of the groove) which is greater from the position near the base portion 5b located radially inside the main gear 5, toward the radially outward side on which the teeth portion 5a is located. That is, in the first annular groove 51, the recessed amount (the depth of the groove) on the radially inner side is greater than that of the radially outer side. In the second annular groove 52, the recessed amount (the depth of the groove) on the radially outer side is greater than that of the radially inner side. A section of the main gear 5 taken along the rotation axis has a Z shape by the teeth portion 5a, the base portion 5b, and the small thickness portion 5c. Moreover, the first annular groove 51 and the second annular groove 52 are at least partially overlapped with each other when viewed from the rotation axis direction. In the first embodiment, the first annular groove 51 and the second annular groove 52 are entirely overlapped with each other when viewed from the rotation axis direction.

In a case where the radius of curvature R1 of the curved surface portion 51a is compared with the radius of curvature R2 of the curved surface portion 52a, the radius of curvature R1 is greater than the radius of curvature R2 (R1>R2). Moreover, a radial width D1 of the first annular groove 51 is identical to a radial width D2 of the second annular groove 52 (D1=D2), Furthermore, an angle formed by the extension line of the curved surface portion 52b in the second annular groove 52, and the line on the second inner circumference surface 5b4 is represented by θd2. An angle formed by the extension line of the linear line portion 51b in the first annular groove 51, and the line on the first outer circumference surface 5a3 is represented by θd1. The angle θd2 is greater than the angle θd1 (θd>θd1). Moreover, θd2 and θd1 are acute. Besides, in this embodiment, the line on the first outer circumference surface 5a3 and the line on the second inner circumference surface 5b4 are parallel to the balancer. However, the line on the first outer circumference surface 5a3 and the line on the second inner circumference surface 5b4 may not be parallel to the balancer.

The first annular groove 51 formed on the first side surface includes the first inner circumference surface 5b3 provided on the rotation axis side; and the first outer circumference surface 5a3 which is provided on the teeth portion Sa side in the radial direction with respect to the rotation axis, and which has the axial depth (the depth in the rotation axis direction) smaller than the depth of the first inner circumference surface 5b3. A first bottom portion is positioned in the curved surface portion 51a connecting the first inner circumference surface 5b3 and the first outer circumference surface 5a3. An angle formed by the first bottom portion and the first inner circumference surface 5b3 is acute.

The second annular groove 52 formed on the second side surface is positioned on the opposite side of the first annular groove 51 in the main gear 5 in the rotation axis direction. The second annular groove 52 is overlapped with the first annular groove 51 when viewed from the rotation axis direction. Moreover, the second annular groove 52 includes the second inner circumference surface 5b4 provided on the rotation axis side in the radial direction with respect to the rotation axis; and the second outer circumference surface 5a4 which is provided on the teeth portion 5a side in the radial direction with respect to the rotation axis, and which has the axial depth (the depth in the rotation axis direction) greater than the depth of the second inner circumference surface 5b4. A second bottom portion is positioned in the curved surface portion 52c connecting the second inner circumference surface 5b4 and the second outer circumference surface 5a4. An angle formed by the second bottom portion and the second inner circumference surface 5b4 is obtuse.

A distance from the end surface portion 5a2 of the teeth portion 5a in the second annular groove 52 to the bottom portion of the second annular groove 52 is represented by L2. A distance from the end surface portion 5b1 of the base portion 5b in the first annular groove 51 to the bottom portion of the first annular groove 51 is represented by L1. L1 is longer than L2 (L1>L2). That is, the lengths to the deepest bottom portions of the first annular groove 51 and the second annular groove 52 in the rotation axis direction are different from each other (the depths of the first annular groove 51 and the second annular groove 52 are different from each other).

In this way, the shapes of the first annular groove 51 and the second annular groove 52 are different from each other when viewed in the section taken along the rotation axis in this way.

Moreover, the first annular groove 51 and the second annular groove 52 are at least partially overlapped with each other in the radial direction with respect to the rotation axis. That is, L1 and L2 has an overlapping portion of ΔL.

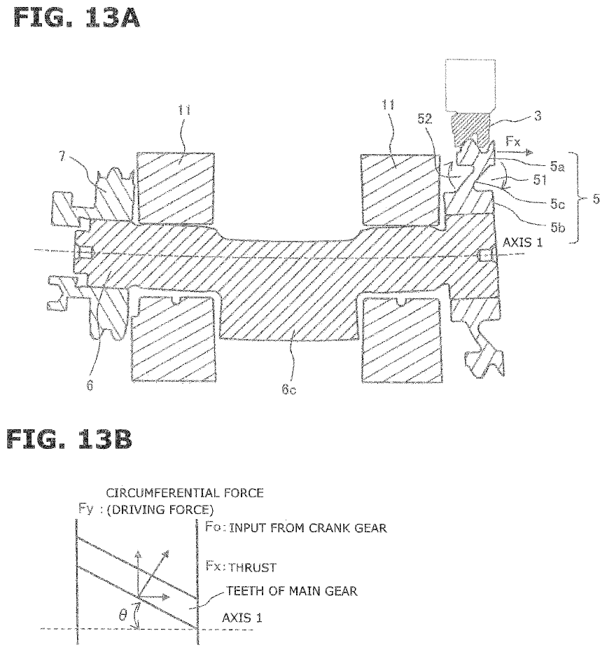

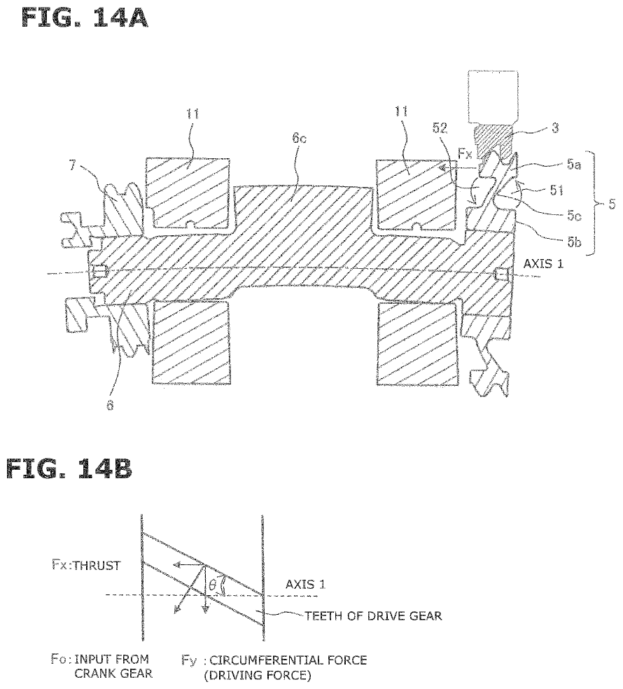

Next, the operation of the main gear 5 including the first annular groove 51 and the second annular groove 52 are explained with reference to FIG. 13A, FIG. 13B, FIG. 14A, and FIG. 14B. FIG. 13A and FIG. 14A are sectional views for explaining the actuation of the main gear and the balancer drive shaft according to the first embodiment of the present invention. FIG. 13B and FIG. 14B are views showing the relationship of the force acted to the main gear according to the first embodiment of the present invention.

The balancer drive shaft 6 is integrally provided with the semi-circular balancer weight 6c (first balancer weight). When the balancer drive shaft 6 is rotated, the balancer drive shaft 6 is curved by the centrifugal force toward the side on which the balancer weight 6c is mounted. In FIG. 13A, the central portion of the balancer drive shaft 6 is curved toward the lower side. In FIG. 14A, the central portion of the balancer drive shaft 6 is curved toward the upper side.

The teeth of the teeth portion 5a of the main gear 5 according to this embodiment is a helical gear having a predetermined torsion angle θ with respect to the rotation axis. The helical gear has contact areas greater than those of a spur gear. The main gear 5 is engaged with the crank gear 3. The driving force of the crank gear 3 is transmitted to the main gear 5. In this embodiment, the main gear 5 is the helical gear. Accordingly, in the state where the central portion of the balancer shaft 6 is curved toward the lower side (FIG. 13A), a direction of the input Fo from the crank gear 3 is a direction perpendicular to the surface of the inclined tooth of the main gear 5, as shown in FIG. 13B. That is, the direction of the input Fo from the crank gear 3 is a direction inclined from the circumferential direction of the main gear 5 (the rotation direction of the main gar 5). The input Fo from the crank gear 3 in the teeth of the main gear 5 is divided into the force Fy in the circumferential direction of the main gear 5 (the rotation direction of the main gear 5), and the thrust Fx in the axial direction (the direction along the axial direction of the rotation axis of the main gear 5). In the state of FIG. 13A, the thrust Fx (positive thrust) is acted to the main gear 5 toward the outer side in the axial direction.

The main gear 5 according to this embodiment includes the first annular groove 51 formed in the first side surface which is in the direction of the thrust force received by the teeth portion 5a; the second annular groove 52 formed in the second side surface which is on the side opposite to the first side surface on which the first annular groove 51 is provided; and the small thickness portion 5c. When the thrust Fx is acted to the main gear 5 in the axially outward direction, the teeth portion 5a of the main gear 5 is moved to narrow the space of the first annular grove 51, and to expand the space of the second annular groove 52. That is, in FIG. 13A, the teeth portion 5a of the main gear 5 is moved in the clockwise direction.

Moreover, in a state where the central portion of the balancer drive shaft 6 is curved toward the upper side (FIG. 14A), the direction of the input Fo from the crank gear 3 is a direction perpendicular to the surface of the inclined tooth of the main gear 5, as shown in FIG. 14B. In this case, the force opposite to the rotation direction is acted. That is, the direction of the input Fo from the crank gear 3 is the direction inclined from the circumferential direction (the counter-rotation direction) of the main gear 5. The input Fo from the crank gear 3 in the teeth of the main gear 5 is divided into the force Fy of the circumferential direction (the counter-rotation direction) of the main gear 5, and the thrust Fx in the axial direction. In the state of FIG. 14A, the thrust Fx (the negative thrust) is acted to the main gear 5 in the axially inward direction.

When the thrust Fx is acted to the main gear 5 in the axially inward direction, the teeth portion 5a of the main gear 5 is moved to narrow the space of the second annular grove 52, and to expand the space of the first annular groove 51. That is, in FIG. 14A, the teeth portion 5a of the main gear 5 is moved in the counterclockwise direction.

The main gear 5 according to this embodiment includes the small thickness portion 5c between the first annular groove 51 and the second annular groove 52, in addition to the first annular groove 51 and the second annular groove 52. Accordingly, when the thrust Fx is acted to the main gear 5, the small thickness portion 5c is bent in accordance with the direction of the thrust Fx. It is possible to absorb the deviation of the engagement between the main gear 5 and the crank gear 3, which is generated by the curvature of the balancer drive shaft 6. With this, it is possible to suppress the teeth hitting noise.

Moreover, the teeth hitting noise is transmitted from the teeth portion 5a through the small thickness portion 5c and the base portion 5b to the balancer drive shaft 6. In this embodiment, the small thickness portion 5c connecting the teeth portion 5a and the base portion 5b of the main gear 5 is disposed to be inclined with respect to the line perpendicular to the rotation axis. Accordingly, it is possible to lengthen the transmission path of the noise transmitted from the teeth portion 5a to the base portion 5b, without increasing the size of the main gear 5. It is possible to suppress the noise transmitted to the balancer drive shaft 6.

Furthermore, in this embodiment, the lengths to the deepest bottom portions of the first annular groove 51 and the second annular groove 52 in the rotation axis direction are different from each other. Accordingly, it is possible to lengthen the transmission path of the noise transmitted from the teeth portion 5a to the base portion 5b, without increasing the size of the main gear 5. It is possible to suppress the noise transmitted to the balancer drive shaft 6.

Moreover, the first annular groove 51 and the second annular groove 52 have the different shapes when viewed in a section taken along the rotation axis. Accordingly, it is possible to control the bending direction of the teeth portion 5a, and the flexibility of the teeth portion 5a.

Furthermore, the first annular groove 51 is entirely overlapped with the second annular groove 52 when viewed from the rotation axis direction. Accordingly, it is possible to alternately form the first annular groove 51 and the second annular groove 52 in the side surface portion of the main gear 5. It is possible to decrease the size of the main gear 5.

Besides, in this embodiment, the small thickness portion 5c is inclined so that the side opposite to the balancer weight 6c side in the rotation axis direction directs the radially outer side. Conversely, the small thickness portion 5c may be inclined so that the balancer weight 6c side directs the radially outer side. In this case, the relationship among the first outer circumference surface 5a3, the first inner circumference surface 5b3, the second outer circumference surface 5a4, and the second inner circumference surface 5b4 is reversed.

That is, the first annular groove 51 includes the first inner circumference surface 5b3 provided on the rotation axis side of the balancer drive shaft 6 in the radial direction with respect to the rotation axis; and the first outer circumference surface 5a3 which is provided to confront the first inner circumference surface 5b3, and which has the axial depth (the depth in the rotation axis direction) longer than that of the first inner circumference surface 5b3. Furthermore, the second annular groove 52 includes the second inner circumference surface 5b4 provided on the rotation axis side of the balancer drive shaft 6 in the radial direction with respect to the rotation axis; and the second outer circumference surface 5a4 which is provided to confront the second inner circumference surface 5b4, and which has the axial depth (the depth in the rotation axis direction) longer than that of the first inner circumference surface 5b3.

In the first embodiment, the present invention is applied to the main gear 5. However, the present invention is applicable to the crank gear 3. FIG. 15A is a perspective view showing a crank gear according to this embodiment of the present invention, when viewed from the pump side. FIG. 15B is a perspective view showing the crank gear according to the embodiments of the present invention, when viewed from the opposite pump side. FIG. 15C is a plan view showing the crank gear according to the embodiment of the present invention, when viewed from the opposite pump side. FIG. 15D is a sectional view taken along a direction XVD-XVD in FIG. 15C.

The crank gear 3 includes an opening portion 3d which is formed at the central portion of the crank gear 3, and though which the crank shaft 2 passes. The teeth portion 3a of the crank gear 3 has a predetermined torsion angle with respect to the rotation axis. The teeth portion 3a of the crank gear 3 is engaged with the teeth portion 5a of the main gear 5.

The crank shaft 2 is inserted into the opening portion 3d of the crank gear 3. The base portion 3b of the crank gear 3 is fixed to the crank shaft 2.

The crank gear 3 includes a first annular groove 61 and a second annular groove 62 which are formed on both side surfaces of the crank gear 3 in the rotation axis direction of the crank shaft 2, and which are a plurality of annular grooves. The second annular groove 62 is overlapped with the first annular groove 61 when viewed from the direction of the rotation axis. In addition, the second annular groove 62 is partially overlapped with the first annular groove 61 (the bottom portions of the grooves are overlapped with each other) in the radial direction with respect to the rotation axis. A small thickness portion 3c is formed between the first annular groove 61 and the second annular groove 62. The small thickness portion 3c is disposed so as to be inclined to the opposite pump side (the inside) of the rotation axis of the crank shaft 2 from the base portion 3b of the crank gear 3 toward the teeth portion 3a.

The first annular groove 61 and the second annular groove 62 have the configurations identical to those of the above-described main gear 5. With this, it is possible to obtain the identical effects.

Moreover, in a case where the present invention is applied to both the crank gear 3 and the main gear 5, it is possible to further absorb the deviation of the engagement of the main gear 5 and the crank gear 3. It is possible to further suppress the teeth hitting noise relative to a case where the present invention is applied to one of the crank gear 3 and the main gear 5.

Similarly, in a case where the present invention is applied to both the balancer drive gear 7 and the balancer driven gear 8, it is possible to further absorb the deviation of the engagement of the balancer drive gear 7 and the balancer driven gear 8. It is possible to further suppress the teeth hitting noise relative to a case where the present invention is applied to one of the balancer drive gear 7 and the balancer driven gear 8.

Moreover, in a case where the present invention is applied to both the oil pump drive gear 21 and the oil pump driven gear 43, it is possible to further absorb the deviation of the engagement of the oil pump drive gear 21 and the oil pump driven gear 43. It is possible to further suppress the teeth hitting noise relative to a case where the present invention is applied to one of the oil pump drive gear 21 and the oil pump driven gear 43.

### Second Embodiment

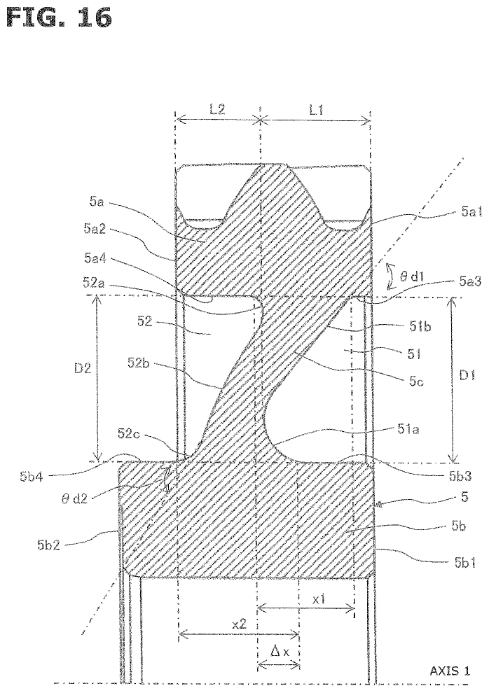

Next, a second embodiment is explained with reference to FIG. 16. FIG. 16 is a sectional view showing a main gear according to the second embodiment of the present invention. Configurations identical to those of the first embodiment have identical symbols. Detailed explanations thereof are omitted.

The main gear 5 includes the first annular groove 51 and the second annular groove 52 which are formed on both side surfaces of the main gear 5 in the rotation axis direction of the balancer drive shaft 6, and which are a plurality of annular grooves. The small thickness portion 5c is formed between the first annular groove 51 and the second annular groove 52. The small thickness portion 5c is disposed and inclined from the base portion 5b of the main gear 5 to the teeth portion 5a of the main gear 5 in the extension direction (the outside) of the rotation axis of the balancer drive shaft 6.

A distance from the end surface portion 5a1 of the teeth portion 5a (the end surface portion 5b of the base portion 5b) in the first annular groove 51 to the bottom portion of the first annular groove 51 is represented by L1. A distance from the end surface portion 5a2 of the teeth portion 5a in the second annular groove 52 to the bottom portion of the second annular groove 52 is represented by L2. In a range between the end surface portion 5a1 to the end surface portion 5a2 of the teeth portion 5a, L1 and L2 are not overlapped with each other in the radial direction with respect to the rotation axis. That is, the bottom portion of the first annular groove 51 and the bottom portion of the second annular groove 52 are positioned on the line extending in the radial direction perpendicular to the rotation axis. Moreover, L1+L2 is identical to a distance between the end surface portion 5a1 and the end surface portion 5a2.

Moreover, a distance from a boundary portion between the first outer circumference surface 5a3 and the linear line portion 51b in the first annular groove 51 to a boundary portion between the second outer circumference surface 5a4 and the curved surface portion 52a is represented by x1. A distance from a boundary portion between the curved surface portion 52c and the second inner circumference surface 5b4 of the base portion 5b to a boundary portion between the first inner circumference surface 5b3 and the curved surface portion 51a is represented by x2. That is, x1 is an axial width (a width in the rotation axis direction) of the small thickness portion 5c on the teeth portion 5a side. X2 is an axial width (a width in the rotation axis direction) of the small thickness portion 5c on the base portion 5b side. In this embodiment, x1 and x2 are overlapped by Δx with each other in the rotation axis direction. Moreover, the distance x1 is identical to the distance x2 (x1=x2). That is, in the small thickness portion 5c in this embodiment, the axial width (x1) (the width in the rotation axis direction) of the portion connected to the teeth portion 5a side is identical to the axial width (x2) (the width in the rotation axis direction) of the portion connected to the base end portion 5b side. Moreover, x1 is partially overlapped with x2. That is, x1 is overlapped with x2 by Δx.

The main gear 5 according to this embodiment includes the small thickness portion 5c between the first annular groove 51 and the second annular groove 52, in addition to the first annular groove 51 and the second annular groove 52. Accordingly, when the thrust Fx is acted to the main gear 5, the small thickness portion 5c is bent in accordance with the direction of the thrust Fx. It is possible to absorb the deviation of the engagement between the main gear 5 and the crank gear 3, which is generated by the curvature of the balancer drive shaft 6. With this, it is possible to suppress the teeth hitting noise.

Moreover, the teeth hitting noise is transmitted from the teeth portion 5a through the small thickness portion 5c and the base portion 5b to the balancer drive shaft 6. In this embodiment, the small thickness portion 5c connecting the teeth portion 5a and the base portion 5b of the main gear 5 is disposed to be inclined with respect to the line perpendicular to the rotation axis. Accordingly, it is possible to lengthen the transmission path of the noise transmitted from the teeth portion 5a to the base portion 5b, without increasing the size of the main gear 5. It is possible to suppress the noise transmitted to the balancer drive shaft 6.

Furthermore, in this embodiment, the first annular groove 51 is not overlapped with the second annular groove 52 in the radial direction with respect to the rotation axis when viewed in the section taken along the rotation axis. Accordingly, the small thickness portion 5c is easy to be bent.

Moreover, in this embodiment, the small thickness portion 5c has the overlapped portion of Δx which is a part when viewed from the radial direction perpendicular to the rotation axis. Accordingly, it is possible to ensure the strength against the load in the radial direction.

### Third Embodiment

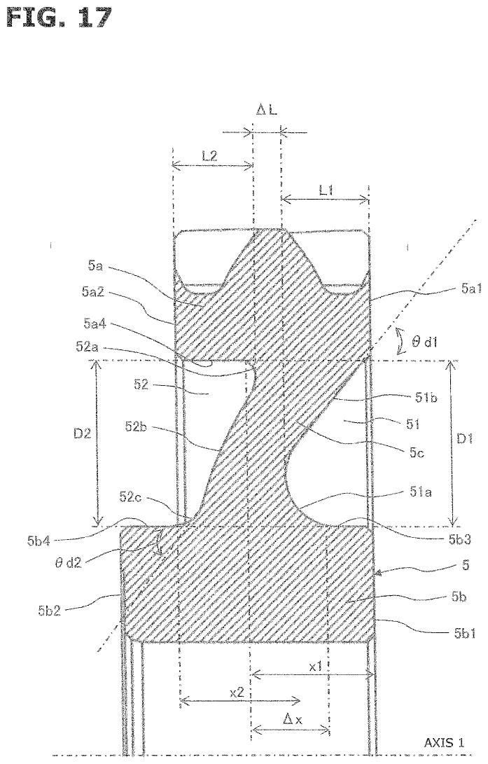

Next, a third embodiment is explained with reference to FIG. 17. FIG. 17 is a sectional view showing a main gear according to the third embodiment of the present invention. Configurations identical to those of the first embodiment and the second embodiment have identical symbols. Detailed explanations thereof are omitted.

The main gear 5 includes the first annular groove 51 and the second annular groove 52 which are formed on both side surfaces of the main gear 5 in the rotation axis direction of the balancer drive shaft 6, and which are a plurality of annular grooves. The small thickness portion 5c is formed between the first annular groove 51 and the second annular groove 52. The small thickness portion 5c is disposed and inclined from the base portion 5b of the main gear 5 to the teeth portion 5a of the main gear 5 in the extension direction (the outside) of the rotation axis of the balancer drive shaft 6.

A distance from the end surface portion 5a1 of the teeth portion 5a (the end surface portion 5b of the base portion 5b) in the first annular groove 51 to the bottom portion of the first annular groove 51 is represented by L1. A distance from the end surface portion 5a2 of the teeth portion 5a in the second annular groove 52 to the bottom portion of the second annular groove 52 is represented by L2. In a range between the end surface portion 5a1 to the end surface portion 5a2 of the teeth portion 5a, L1 and L2 are not overlapped with each other. L1 is apart from L2 by ΔL. That is, the bottom portion of the first annular groove 51 is apart from the bottom portion of the second annular groove 52 by ΔL in the radial direction perpendicular to the rotation axis.

Moreover, a distance from the end surface portion 5b1 of the base portion 5b (the end surface portion 5a1 of the teeth portion 5a) in the first annular groove 51 to a boundary portion between the second outer circumference 5a4 and the curved surface portion 52a is represented by x1. A distance from a boundary portion between the second inner circumference surface 5b4 (the end surface portion 5a2 of the teeth portion 5a) and the curved surface portion 52c to a boundary portion between the first inner circumference surface 5b3 and the curved surface portion 51a is represented by x2. That is, x1 is an axial width (a width in the rotation axis direction) of the small thickness portion 5c on the teeth portion 5a side. X2 is an axial width (a width in the rotation axis direction) of the small thickness portion 5c on the base portion 5b side. In this embodiment, x1 and x2 are overlapped by Δx with each other in the rotation axis direction. Moreover, the distance x1 is identical to the distance x2 (x1=x2). That is, in the small thickness portion 5c in this embodiment, the axial width (x1) (the width in the rotation axis direction) of the portion connected to the teeth portion 5a side is identical to the axial width (x2) (the width in the rotation axis direction) of the portion connected to the base end portion 5b side.

The main gear 5 according to this embodiment includes the small thickness portion 5c between the first annular groove 51 and the second annular groove 52, in addition to the first annular groove 51 and the second annular groove 52. Accordingly, when the thrust Fx is acted to the main gear 5, the small thickness portion 5c is bent in accordance with the direction of the thrust Fx. It is possible to absorb the deviation of the engagement between the main gear 5 and the crank gear 3, which is generated by the curvature of the balancer drive shaft 6. With this, it is possible to suppress the teeth hitting noise.

Moreover, the teeth hitting noise is transmitted from the teeth portion 5a through the small thickness portion 5c and the base portion 5b to the balancer drive shaft 6. In this embodiment, the small thickness portion 5c connecting the teeth portion 5a and the base portion 5b of the main gear 5 is disposed to be inclined with respect to the line perpendicular to the rotation axis. Accordingly, it is possible to lengthen the transmission path of the noise transmitted from the teeth portion 5a to the base portion 5b, without increasing the size of the main gear 5. It is possible to suppress the noise transmitted to the balancer drive shaft 6.

Furthermore, in this embodiment, the first annular groove 51 is not overlapped with the second annular groove 52 in the radial direction with respect to the rotation axis when viewed in the section taken along the rotation axis. Accordingly, the small thickness portion 5c is easy to be bent.

Moreover, in this embodiment, the small thickness portion 5c has the overlapped portion of ΔL on the teeth portion 5a side, and the overlapped portion of Δx on the base portion 5b side when viewed in the radial direction perpendicular to the rotation axis. Accordingly, it is possible to ensure the strength against the load in the radial direction.

### Fourth Embodiment

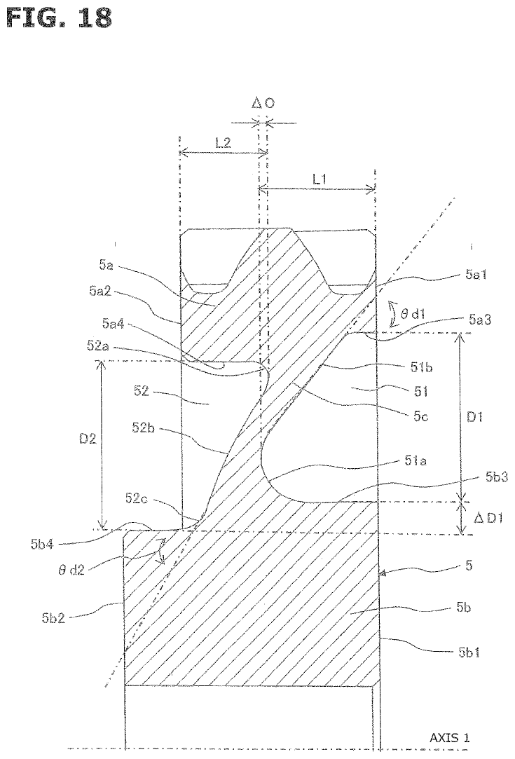

Next, a fourth embodiment is explained with reference to FIG. 18. FIG. 18 is a sectional view showing a main gear according to the fourth embodiment of the present invention. Configurations identical to those of the first embodiment to the third embodiment have identical symbols. Detailed explanations thereof are omitted.

The main gear 5 includes the first annular groove 51 and the second annular groove 52 which are formed on both side surfaces of the main gear 5 in the rotation axis direction of the balancer drive shaft 6, and which are a plurality of annular grooves. The small thickness portion 5c is formed between the first annular groove 51 and the second annular groove 52. The small thickness portion 5c is disposed and inclined from the base portion 5b of the main gear 5 to the teeth portion 5a of the main gear 5 in the extension direction (the outside) of the rotation axis of the balancer drive shaft 6.

A distance from the end surface portion 5a1 of the teeth portion 5a (the end surface portion 5b of the base portion 5b) in the first annular groove 51 to the bottom portion of the first annular groove 51 is represented by L1. A distance from the end surface portion 5a2 of the teeth portion 5a in the second annular groove 52 to the bottom portion of the second annular groove 52 is represented by L2. In a range between the end surface portion 5a1 to the end surface portion 5a2 of the teeth portion 5a, L1 is overlapped with L2 by AO. That is, the bottom portion of the first annular groove 51 is overlapped with the bottom portion of the second annular groove 52 by AO in the radial direction perpendicular to the rotation axis.

Moreover, the first annular groove 51 is disposed radially outside the second annular groove 52 by LD1 in the radial direction with respect to the rotation axis.

By this embodiment, the first annular groove 51 is partially overlapped with the second annular groove 52 in the rotation axis direction when viewed in the section taken along the rotation axis. Accordingly, the small thickness portion 5c is easy to be bent.

The main gear 5 according to this embodiment includes the small thickness portion 5c between the first annular groove 51 and the second annular groove 52, in addition to the first annular groove 51 and the second annular groove 52. Accordingly, when the thrust Fx is acted to the main gear 5, the small thickness portion 5c is bent in accordance with the direction of the thrust Fx. It is possible to absorb the deviation of the engagement between the main gear 5 and the crank gear 3, which is generated by the curvature of the balancer drive shaft 6. With this, it is possible to suppress the teeth hitting noise.

### Fifth Embodiment

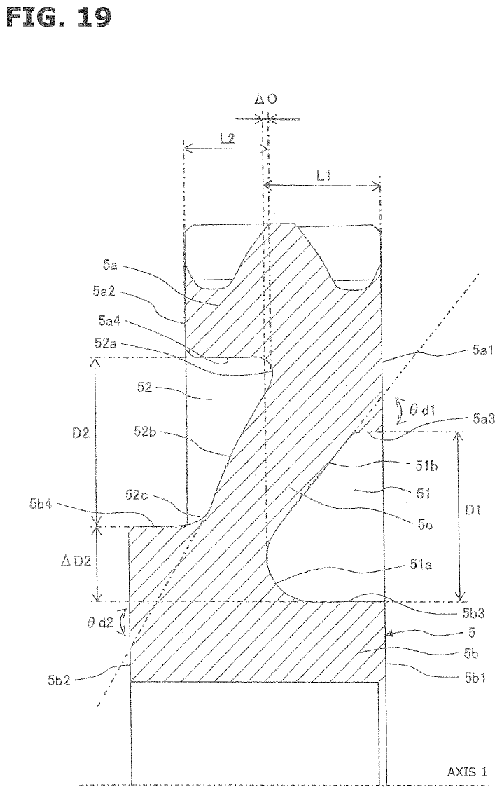

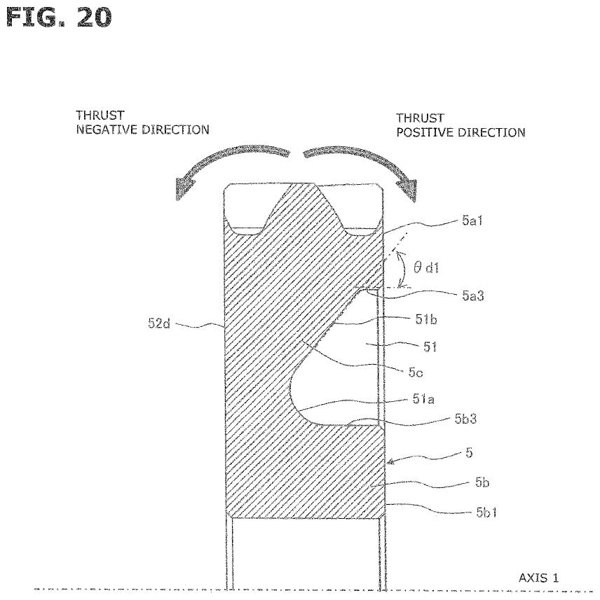

Next, a fifth embodiment is explained with reference to FIG. 19. FIG. 19 is a sectional view showing a main gear according to the fifth embodiment of the present invention. Configurations identical to those of the first embodiment to the fourth embodiment have identical symbols. Detailed explanations thereof are omitted.

The main gear 5 includes the first annular groove 51 and the second annular groove 52 which are formed on both side surfaces of the main gear 5 in the rotation axis direction of the balancer drive shaft 6, and which are a plurality of annular grooves. The small thickness portion 5c is formed between the first annular groove 51 and the second annular groove 52. The small thickness portion 5c is disposed and inclined from the base portion 5b of the main gear 5 to the teeth portion 5a of the main gear 5 in the extension direction (the outside) of the rotation axis of the balancer drive shaft 6.

A distance from the end surface portion 5a1 of the teeth portion 5a (the end surface portion 5b of the base portion 5b) in the first annular groove 51 to the bottom portion of the first annular groove 51 is represented by L1. A distance from the end surface portion 5a2 of the teeth portion 5a in the second annular groove 52 to the bottom portion of the second annular groove 52 is represented by L2. In a range between the end surface portion 5a1 to the end surface portion 5a2 of the teeth portion 5a, L1 is overlapped with L2 by ΔO. That is, the bottom portion of the first annular groove 51 is overlapped with the bottom portion of the second annular groove 52 by AO in the radial direction perpendicular to the rotation axis.

Moreover, the second annular groove 52 is disposed radially outside the first annular groove 52 by ΔD2 in the radial direction with respect to the rotation axis.

By this embodiment, the first annular groove 51 is partially overlapped with the second annular groove 52 in the rotation axis direction when viewed in the section taken along the rotation axis. Accordingly, the small thickness portion 5c is easy to be bent.

The main gear 5 according to this embodiment includes the small thickness portion 5c between the first annular groove 51 and the second annular groove 52, in addition to the first annular groove 51 and the second annular groove 52. Accordingly, when the thrust Fx is acted to the main gear 5, the small thickness portion 5c is bent in accordance with the direction of the thrust Fx. It is possible to absorb the deviation of the engagement between the main gear 5 and the crank gear 3, which is generated by the curvature of the balancer drive shaft 6. With this, it is possible to suppress the teeth hitting noise.

Moreover, in this embodiment, the second annular groove 52 is disposed radially outside the first annular groove 51 by ΔD2 in the radial direction with respect to the rotation axis. The small thickness portion 5 is further easy to be bent on the first annular groove 51 side positioned radially inside the second annular groove 52.

### Sixth Embodiment

Next, a sixth embodiment is explained with reference to FIG. 20. FIG. 20 is a sectional view showing a main gear according to the sixth embodiment of the present invention. Configurations identical to those of the first embodiment to the fifth embodiment have identical symbols. Detailed explanations thereof are omitted.

In the first embodiment to the fifth embodiment, the balancer weight 6c is mounted to the balancer drive shaft 6. Accordingly, the balancer drive shaft 6 is bent so that the thrust force becomes the positive region and the negative region. For example, when the balancer weight is not mounted to the shaft, the thrust force does not become the negative region. The thrust force is varied in the positive region. In the case of this shaft, it is possible to omit the second annular groove 52 provided to the main gear in the first embodiment to the fifth embodiment. In the sixth embodiment, the main gear 5 is the helical gear like the first embodiment to the fifth embodiment. The directions of the teeth of the main gear are identical to those of FIG. 12B.

The main gear 5 includes the first annular groove 51 formed in the one surface in the rotation axis direction of the balancer drive shaft 6. The first annular groove 51 including the small thickness portion 5c includes the curved surface portion 51a which is formed at the position confronting the first annular groove 51 in the rotation axis direction, which is recessed from the axial end surface portion 5b1 of the base portion 5b in the axially inward direction, and which includes the recessed bottom portion having the predetermined radius of the curvature. The end surface portion 5b1 and the curved surface portion 51a are connected by the first inner circumference surface 5b3 of the base portion 5b. The first inner circumference surface 5b3 is provided on the rotation axis side. The linear line portion 51b is formed in the surface of the small thickness portion 5c linearly extending from the curved surface portion 51a in the radially outward direction. The small thickness portion 51b is connected to the first outer circumference surface 5a3 of the teeth portion 5a of the main gear 5. The first outer circumference surface 5a3 is connected to the end surface portion 5a1. The first inner circumference surface 5b3 confronts the first outer circumference surface 5a3. The axial depth (the depth in the axial direction) of the first outer circumference surface 5a3 is smaller than that of the first inner circumference surface 5b3.

The annular groove 51 includes the first inner circumference surface 5b3 provided on the rotation axis side; and the first outer circumference surface 5a3 provided on the teeth portion 5a side, and which has the depth smaller than that of the first inner circumference surface 5b3. The first bottom portion is positioned in the curved surface portion 51a connecting the first inner circumference surface 5b3 and the first outer circumference surface 5a3. An angle formed by the first bottom portion and the first inner circumference surface 5b3 is acute.

The main gear 5 according to this embodiment includes the first annular groove 51. Accordingly, when the thrust Fx is applied to the main gear 5, the small thickness portion 5c is bent in accordance with the direction of the thrust Fx. It is possible to absorb the deviation of the engagement between the main gear 5 and the crank gear 3. With this, it is possible to absorb the teeth hitting noise.

Moreover, in this embodiment, the first annular groove 51 is formed only in the one side of the main gear 5. Accordingly, it is possible to readily form the main gear 5. Furthermore, when the main gear 5 is cleaned, in a case where the main gear 5 is located to direct the first annular groove 51 side in the downward direction, it is possible to fasten the drying process without accumulating the cleaning solvent within the groove formed by the processing.

Besides, the present invention is not limited to the above-described embodiments. The present invention includes various variations. The above-described embodiments are explained in detail for the easy understanding of the present invention. The present invention is not limited to the configuration including the all explained components.

The embodiments according to the present invention include the balancer drive shaft 6 and the main gear 5 fixed to the balancer drive shaft 6. Moreover, the present invention is applicable to a mere combination between a shaft and a gear (the effects in the respective embodiments). In recent years, it is required to further improve the fuel economy for improving the environment performance. For the improvement of the fuel economy, it is required to decrease the weight of the engine. It is necessary to avoid the size increase of the components constituting the engine. The embodiments are focused on the improvement to suppress the noise, and to suppress the size increase of the components.

In the embodiments, a main gear 5 (gear) configured to rotate as a unit with a balancer drive shaft 6 (shaft), the main gear 5 including:

a first annular groove 51 and a second annular groove 52 (a plurality of annular grooves) formed on both side surfaces of the main gear 5 (gear) in a direction of a rotation axis of the balancer drive shaft 6 (shaft), at least partially overlapped when viewed from the direction of the rotation axis of the balancer drive shaft 6, and at least partially overlapped in a radial direction with respect to the rotation axis.

In this embodiment, it is possible to lengthen the transmission path of the noise. Accordingly, it is possible to provide a gear to suppress the noise generated by the engagement of the gears, and to suppress the size increase.

Moreover, in the above-described configuration in the embodiment, a first annular groove 51 is provided on one side surface of the both side surfaces of the main gear 5 (gear) in the direction of the rotation axis, and a second annular groove 52 is provided on a side opposite to the first annular groove 51; and depths of deepest bottom portions of the first annular groove 51 and the second annular groove 52 in the direction of the rotation axis are different from each other.

In this embodiment, it is possible to lengthen the transmission path of the noise. Accordingly, it is possible to provide a gear to suppress the noise generated by the engagement of the gears, and to suppress the size increase.

Moreover, in the above-described configuration in the embodiment, the shapes of the first annular groove 51 and the second annular groove 52 are different from each other.

In this embodiment, it is possible to control the gear bending direction, and to suppress the noise generated by the engagement of the gears.

Moreover, in the above-described configuration in the embodiment, the first annular groove 51 includes a first inner circumference surface 5b3 provided on the rotation axis side in the radial direction with respect to the rotation axis, and a first outer circumference surface 5a3 which confronts the first inner circumference surface 5b3, and which has an axial depth smaller than an axial depth of the first inner circumference surface 5b3; and

the second annular groove 52 includes a second inner circumference surface 5b4 provided on the rotation axis side in the radial direction with respect to the rotation axis, and a second outer circumference surface 5a4 which confronts the second inner circumference surface 5b4, and which has an axial depth greater than an axial depth of the second inner circumference surface 5b4.

In this embodiment, the gear is easy to be bent on the first annular groove 51 side. It is possible to suppress the noise generated by the engagement of the gears.

Moreover, in the above-described configuration in the embodiment, the first annular groove 51 is deviated from the second annular groove 52 in the radial direction with respect to the rotation axis.

In this embodiment, the gear is easy to be bent on the first annular groove 51 side. It is possible to suppress the noise generated by the engagement of the gears.

Moreover, in the above-described configuration in the embodiment, the first annular groove 51 and the second annular groove 52 of the plurality of the annular grooves are entirely overlapped when viewed in the direction of the rotation axis.

In this embodiment, it is possible to lengthen the transmission path of the noise. Accordingly, it is possible to provide a gear to suppress the noise generated by the engagement of the gears, and to suppress the size increase.

Moreover, in the above-described configuration in the embodiment, the main gear 5 (gear) including the first annular groove 51 and the second annular groove 52 (the plurality of the annular grooves) has a Z shape when viewed in a section taken along the rotation axis.

In this embodiment, it is possible to lengthen the transmission path of the noise. Accordingly, it is possible to provide a gear to suppress the noise generated by the engagement of the gears, and to suppress the size increase.

Furthermore, in this embodiment, a main gear 5 (gear) configured to rotate as a unit with a balancer drive shaft 6 (shaft), the main gear 5 (gear) including:

a teeth portion 5a which are provided in a circumferential direction with respect to the rotation axis of the balancer drive shaft (shaft), and which has a predetermined torsion angle with respect to the rotation axis; and

a first annular groove 51 which is formed on a first side surface of both side surfaces of the main gear 5 (gear) in a direction of the rotation axis, the first side surface being on a direction of a thrust force received by the teeth portion 5a, the first annular groove 51 including;
a first inner circumference surface 5b3 provided on the rotation axis side in a radial direction with respect to the rotation axis,
a first outer circumference surface 5a3 which is provided on the teeth portion 5a side in the radial direction with respect to the rotation axis, and which has an axial depth smaller than an axial depth of the first inner circumference surface 5b3, and
a first bottom portion connecting the first inner circumference surface 5b3 and the first outer circumference surface 5a3, and having an angle which is formed by the first bottom portion and the first inner circumference surface 5b3, and which is acute.

In this embodiment, it is possible to lengthen the transmission path of the noise. Accordingly, it is possible to provide a gear to suppress the noise generated by the engagement of the gears, and to suppress the size increase.

Moreover, in this embodiment, the first annular groove 51 is formed only in the one side of the main gear 5. Accordingly, it is possible to readily form the main gear 5. Furthermore, when the main gear 5 is cleaned, in a case where the main gear 5 is located to direct the first annular groove 51 side in the downward direction, it is possible to fasten the drying process without accumulating the cleaning solvent within the groove formed by the processing.

Moreover, in the above-described configuration in the embodiment, the main gear 5 (gear) includes a second annular groove 52 that is formed on a second side surface of the both side surfaces of the main gear 5 (gear) in the direction of the rotation axis, the second side surface being opposite to the first side surface on which the first annular groove 51 is formed, and that is overlapped with the first annular groove 51 when viewed in the direction of the rotation axis;

the second annular groove 52 includes
a second inner circumference surface 5b4 provided on the rotation axis side in a radial direction with respect to the rotation axis,
a second outer circumference surface 5a4 which is provided on the teeth portion 5a side in the radial direction with respect to the rotation axis, and which has an axial depth greater than an axial depth of the second inner circumference surface 5b4, and
a second bottom portion connecting the second inner circumference surface 5b4 and the second outer circumference surface 5a4, and having an angle which is formed by the second bottom portion and the second inner circumference surface 5b4, and which is obtuse.

In this embodiment, it is possible to lengthen the transmission path of the noise. Accordingly, it is possible to provide a gear to suppress the noise generated by the engagement of the gears, and to suppress the size increase.

Moreover, in the above-described configuration in the embodiment, the first annular groove 51 is not′ overlapped with the second annular groove 52 in the radial direction with respect to the rotation axis when viewed in a section taken along the rotation axis.

In this embodiment, the main gear 5 is easy to be bent. It is possible to ensure the predetermined strength with respect to the load in the radial direction.

Moreover, in this embodiment, a balancer device including:

a balancer drive shaft 6 provided with a balancer weight 6c;

a main gear 5 (drive gear) configured to rotate as a unit with the balancer drive shaft 6, and to which a rotation force is transmitted from a crank shaft 2 through a crank gear 3;

a plurality of annular grooves (first annular groove 51 and second annular groove 52) which are formed on both side surfaces of the main gear 5 (drive gear) in a direction of a rotation axis of the balancer drive shaft 6, which are at least partially overlapped when viewed in the direction of the rotation axis, and which are at least partially overlapped in a radial direction with respect to the rotation axis.

In this embodiment, it is possible to lengthen the transmission path of the noise. Accordingly, it is possible to provide the balancer device to suppress the noise generated by the engagement of the gears, and to suppress the size increase.

Moreover, in the above-described configuration in the embodiment, the overlapped portions of the plurality of the annular grooves (first annular groove 51 and second annular groove 52) in the radial direction with respect to the rotation axis is positioned on a side opposite to a side on which a thrust force is applied in the direction of the rotation axis.

In this embodiment, the side receiving the thrust force is easy to be gent. Accordingly, it is possible to provide the balancer device to suppress the noise generated by the engagement of the gears, and to suppress the size increase.

Moreover, in the above-described configuration in the embodiment, the plurality of the annular grooves includes a second annular groove 52 provided on the balancer weight 6c side in the direction of the rotation axis, and a first annular groove 51 provided on a side opposite to the second annular groove 52; and depths of deepest bottom portions of the first annular groove 51 and the second annular groove 52 in the direction of the rotation axis are different from each other.

In this embodiment, it is possible to lengthen the transmission path of the noise. Accordingly, it is possible to provide the balancer device to suppress the noise generated by the engagement of the gears, and to suppress the size increase.

Moreover, in the above-described configuration in the embodiment, the plurality of the annular grooves includes a second annular groove 52 provided on the balancer weight 6c side in the direction of the rotation axis, and a first annular groove 51 provided on a side opposite to the second annular groove 52; and shapes of the first annular groove 51 and the second annular groove 52 are different from each other when viewed in a section taken along the rotation axis.

In this embodiment, it is possible to control the gear bending direction, and to suppress the noise generated by the engagement of the gears.

Moreover, in the above-described configuration in the embodiment, the first annular groove 51 includes a first inner circumference surface 5b3 provided on the rotation axis side of the balancer drive shaft 6 in the radial direction with respect to the rotation axis, and a first outer circumference surface 5a3 which confronts the first inner circumference surface 5b3, and which has an axial depth smaller than an axial depth of the first inner circumference surface 5b3; and

the second annular groove 52 includes a second inner circumference surface 5b4 provided on the rotation axis side of the balancer drive shaft 6 in the radial direction with respect to the rotation axis, and a second outer circumference surface 5a4 which confronts the second inner circumference surface 5b4, and which has an axial depth greater than an axial depth of the first inner circumference surface 5b4.

In this embodiment, it is possible to lengthen the transmission path of the noise. Accordingly, it is possible to provide the balancer device to suppress the noise generated by the engagement of the gears, and to suppress the size increase.

Moreover, in the above-described configuration in the embodiment, the first annular groove 51 includes a first inner circumference surface 5b3 provided on the rotation axis side of the balancer drive shaft 6 in the radial direction with respect to the rotation axis, and a first outer circumference surface 5a3 which confronts the first inner circumference surface 5b3, and which has an axial depth greater than an axial depth of the first inner circumference surface 5b3; and

the second annular groove 52 includes a second inner circumference surface 5b4 provided on the rotation axis side of the balancer drive shaft 6 in the radial direction with respect to the rotation axis, and a second outer circumference surface 5a4 which confronts the second inner circumference surface 5b4, and which has an axial depth smaller than an axial depth of the first inner circumference surface 5b4.

In this embodiment, it is possible to lengthen the transmission path of the noise. Accordingly, it is possible to provide the balancer device to suppress the noise generated by the engagement of the gears, and to suppress the size increase.

Moreover, in the above-described configuration in the embodiment, the main gear 5 (drive gear) includes a small thickness portion 5c formed between the first annular groove 51 and the second annular groove 52 of the plurality of the annular grooves; and the small thickness portion 5c is inclined so that a side opposite to the balancer weight 6c side in the direction of the rotation axis directs in a radially outward direction.

In this embodiment, it is possible to lengthen the transmission path of the noise. Accordingly, it is possible to provide the balancer device to suppress the noise generated by the engagement of the gears, and to suppress the size increase.

Furthermore, in this embodiment, a balancer device including:

a main gear 5 (drive gear) engaged with a crank gear 3 (input gear) to which a rotation force is transmitted from a crank shaft 2;

a balancer drive shaft 6 to which the rotation force is transmitted from the main gear 5 (drive gear), and which includes a balancer weight 6c (first balancer weight);

a balancer drive gear 7 configured to rotate as a unit with the balancer drive shaft 6;

a balancer driven gear 8 engaged with the balancer drive gear 7;

a balancer driven shaft 9 which is configured to rotate as a unit with the balancer driven gear 8, and which includes a balancer weight 9 (second balancer weight); and

a plurality of annular groove (first annular groove and second annular groove) which are formed in both side surfaces of at least one of the main gear 5 (drive gear), the balancer drive gear 7, and the balancer driven gear 8, in a rotation axis of the balancer drive shaft 6, which are at least partially overlapped when viewed in the direction of the rotation axis, and which are at least partially overlapped in a radial direction with respect to the rotation axis.

In this embodiment, it is possible to lengthen the transmission path of the noise. Accordingly, it is possible to provide the balancer device to suppress the noise generated by the engagement of the gears, and to suppress the size increase.

Moreover, in the above-described configuration in the embodiment, the balancer device includes an oil pump 4 including an oil pump drive gear 21 provided to the balancer driven shaft 9, and an oil pump driven gear 43 engaged with the oil pump drive gear 21; and

a plurality of annular groove (first annular groove and second annular groove) which are formed in both side surfaces of at least one of the main gear 5 (drive gear), the balancer drive gear 7, the balancer driven gear 8, the oil pump drive gear 21, and the oil pump driven gear 43 in a rotation axis of the balancer drive shaft 6, which are at least partially overlapped when viewed in the direction of the rotation axis, and which are at least partially overlapped in a radial direction with respect to the rotation axis.

In this embodiment, it is possible to lengthen the transmission path of the noise. Accordingly, it is possible to provide the balancer device to suppress the noise generated by the engagement of the gears, and to suppress the size increase.

### EXPLANATION OF SYMBOLS

1 . . . balancer device, 2 . . . crank shaft, 3 . . . crank gear (input gear), 3a . . . teeth portion, 3b . . . base portion, 3c . . . small thickness portion, 4 . . . oil pump, 5 . . . main gear (drive gear), 5a . . . teeth portion, 5a1 . . . end surface portion, 5a2 . . . end surface portion, 5a3 . . . first outer circumference surface, 5a4 . . . second outer circumference surface, 5b . . . base portion, 5b1 . . . end surface portion, 5b2 . . . end surface portion, 5b3 . . . second inner circumference surface, 5b4 . . . second inner circumference surface, 5c . . . small thickness portion, 6 . . . balancer drive shaft, 6c . . . balancer weight, 7 . . . balancer drive gear, 8 . . . balancer driven gear, 9 . . . balancer driven shaft, 9c . . . balancer weight, 21 . . . oil pump drive gear, 43 . . . oil pump driven gear, 51 . . . first annular groove, 51a . . . curved surface portion, 51b . . . linear line portion, 52 . . . second annular groove, 52a . . . curved surface portion, 52b . . . curved surface portion, 61 . . . first annular groove, 62 . . . second annular groove

1. A gear configured to rotate as a unit with a shaft, the gear comprising:
a plurality of annular grooves formed on both side surfaces of the gear in a direction of a rotation axis of the shaft, at least partially overlapped when viewed from the direction of the rotation axis, and at least partially overlapped in a radial direction with respect to the rotation axis.

2. The gear as claimed in claim 1, wherein the plurality of the annular grooves includes a first annular groove provided on one side surface of the both side surfaces of the gear in the direction of the rotation axis, and a second annular groove provided on a side opposite to the first annular groove; and depths of deepest bottom portions of the first annular groove and the second annular groove in the direction of the rotation axis are different from each other.

3. The gear as claimed in claim 1, wherein the plurality of the annular grooves includes a first annular groove provided on one side surface of the both side surfaces of the gear in the direction of the rotation axis, and a second annular groove provided on a side opposite to the first annular groove; and shapes of the first annular groove and the second annular groove are different from each other when viewed in a section taken along the rotation axis.

4. The gear as claimed in claim 3, wherein the first annular groove includes a first inner circumference surface provided on the rotation axis side in the radial direction with respect to the rotation axis, and a first outer circumference surface which confronts the first inner circumference surface, and which has an axial depth smaller than an axial depth of the first inner circumference surface; and
the second annular groove includes a second inner circumference surface provided on the rotation axis side in the radial direction with respect to the rotation axis, and a second outer circumference surface which confronts the second inner circumference surface, and which has an axial depth greater than an axial depth of the second inner circumference surface.

5. The gear as claimed in claim 2, wherein the first annular groove is deviated from the second annular groove in the radial direction with respect to the rotation axis.

6. The gear as claimed in claim 1, wherein the plurality of the annular grooves are entirely overlapped when viewed in the direction of the rotation axis.

7. The gear as claimed in claim 1, wherein the gear including the plurality of the annular grooves has a Z shape when viewed in a section taken along the rotation axis.

8. A gear configured to rotate as a unit with a shaft, the gear comprising:
a teeth portion which are provided in a circumferential direction with respect to the rotation axis of the shaft, and which has a predetermined torsion angle with respect to the rotation axis; and
a first annular groove which is formed on a first side surface of both side surfaces of the gear in a direction of the rotation axis, the first side surface being on a direction of a thrust force received by the teeth portion, the first annular groove including;
a first inner circumference surface provided on the rotation axis side in a radial direction with respect to the rotation axis,
a first outer circumference surface which is provided on the teeth portion side in the radial direction with respect to the rotation axis, and which has an axial depth smaller than an axial depth of the first inner circumference surface, and
a first bottom portion connecting the first inner circumference surface and the first outer circumference surface, and having an angle which is formed by the first bottom portion and the first inner circumference surface, and which is acute.

9. The gear as claimed in claim 8, wherein the gear includes a second annular groove that is formed on a second side surface of the both side surfaces of the gear in the direction of the rotation axis, the second side surface being opposite to the first side surface on which the first annular groove is formed, and that is overlapped with the first annular groove when viewed in the direction of the rotation axis;
the second annular groove includes
a second inner circumference surface provided on the rotation axis side in a radial direction with respect to the rotation axis,
a second outer circumference surface which is provided on the teeth portion side in the radial direction with respect to the rotation axis, and which has an axial depth greater than an axial depth of the second inner circumference surface, and
a second bottom portion connecting the second inner circumference surface and the second outer circumference surface, and having an angle which is formed by the second bottom portion and the second inner circumference surface, and which is obtuse.

10. The gear as claimed in claim 9, wherein the first annular groove is not overlapped with the second annular groove in the radial direction with respect to the rotation axis when viewed in a section taken along the rotation axis.

11. A balancer device comprising:
a balancer drive shaft provided with a balancer weight;
a drive gear configured to rotate as a unit with the balancer drive shaft, and to which a rotation force is transmitted from a crank shaft through a crank gear;
a plurality of annular grooves which are formed on both side surfaces of the drive gear in a direction of a rotation axis of the balancer drive shaft, which are at least partially overlapped when viewed in the direction of the rotation axis, and which are at least partially overlapped in a radial direction with respect to the rotation axis.

12. The balancer device as claimed in claim 11, wherein the overlapped portions of the plurality of the annular grooves in the radial direction with respect to the rotation axis is positioned on a side opposite to a side on which a thrust force is applied in the direction of the rotation axis.

13. The balancer device as claimed in claim 11, wherein the plurality of the annular grooves includes a second annular groove provided on the balancer weight side in the direction of the rotation axis, and a first annular groove provided on a side opposite to the second annular groove; and depths of deepest bottom portions of the first annular groove and the second annular groove in the direction of the rotation axis are different from each other.

14. The balancer device as claimed in claim 11, wherein the plurality of the annular grooves includes a second annular groove provided on the balancer weight side in the direction of the rotation axis, and a first annular groove provided on a side opposite to the second annular groove; and shapes of the first annular groove and the second annular groove are different from each other when viewed in a section taken along the rotation axis.

15. The balancer device as claimed in claim 14, wherein the first annular groove includes a first inner circumference surface provided on the rotation axis side of the balancer drive shaft in the radial direction with respect to the rotation axis, and a first outer circumference surface which confronts the first inner circumference surface, and which has an axial depth smaller than an axial depth of the first inner circumference surface; and
the second annular groove includes a second inner circumference surface provided on the rotation axis side of the balancer drive shaft in the radial direction with respect to the rotation axis, and a second outer circumference surface which confronts the second inner circumference surface, and which has an axial depth greater than an axial depth of the first inner circumference surface.

16. The balancer device as claimed in claim 14, wherein the first annular groove includes a first inner circumference surface provided on the rotation axis side of the balancer drive shaft in the radial direction with respect to the rotation axis, and a first outer circumference surface which confronts the first inner circumference surface, and which has an axial depth greater than an axial depth of the first inner circumference surface; and
the second annular groove includes a second inner circumference surface provided on the rotation axis side of the balancer drive shaft in the radial direction with respect to the rotation axis, and a second outer circumference surface which confronts the second inner circumference surface, and which has an axial depth smaller than an axial depth of the first inner circumference surface.

17. The balancer device as claimed in claim 11, wherein the drive gear includes a small thickness portion formed between the plurality of the annular grooves; and the small thickness portion is inclined so that a side opposite to the balancer weight side in the direction of the rotation axis directs in a radially outward direction.

18. A balancer device comprising:
a drive gear engaged with an input gear to which a rotation force is transmitted from a crank shaft;
a balancer drive shaft to which the rotation force is transmitted from the drive gear, and which includes a first balancer weight;
a balancer drive gear configured to rotate as a unit with the balancer drive shaft;
a balancer driven gear engaged with the balancer drive gear;
a balancer driven shaft which is configured to rotate as a unit with the balancer driven gear, and which includes a second balancer weight; and
a plurality of annular groove which are formed in both side surfaces of at least one of the drive gear, the balancer drive gear, and the balancer driven gear, in a rotation axis of the balancer drive shaft, which are at least partially overlapped when viewed in the direction of the rotation axis, and which are at least partially overlapped in a radial direction with respect to the rotation axis.

19. The balancer device as claimed in claim 18, wherein the balancer device includes an oil pump including an oil pump drive gear provided to the balancer driven shaft, and an oil pump driven gear engaged with the oil pump drive gear; and the balancer device includes the plurality of annular groove which are formed in both side surfaces of at least one of the drive gear, the balancer drive gear, the balancer driven gear, the oil pump drive gear, and the oil pump driven gear, in a rotation axis of the balancer drive shaft, which are at least partially overlapped when viewed in the direction of the rotation axis, and which are at least partially overlapped in a radial direction with respect to the rotation axis.
